(19) United States
(12) Patent Application Publication
(10) Pub. No.: US 2022/0325026 A1
(43) Pub. Date: Oct. 13, 2022

(54) PHASE TRANSFER ACTIVE TRIMERIZATION CATALYST SALTS

(71) Applicant: EVONIK OPERATIONS GMBH, Essen (DE)

(72) Inventors: Juan Jesus BURDENIUC, Colmar, PA (US); Torsten Panitzsch, Henstedt-Ulzburg (DE); Rennee Jo Keller, Orwigsburg, PA (US); David VanderSande, Allentown, PA (US)

(73) Assignee: EVONIK OPERATIONS GMBH, Essen (DE)

(21) Appl. No.: 17/639,218

(22) PCT Filed: Sep. 3, 2020
(86) PCT No.: PCT/EP2020/074514

§ 371 Date: Feb. 28, 2022

Related U.S. Application Data
(60) Provisional application No. 62/895,618, filed on Sep. 4, 2019.

(51) Int. Cl. C08G 18/09; C08G 18/02; C08G 18/18; C08G 18/16; C08J 9/14; C08J 9/12

(52) U.S. Cl. CPC C08G 18/092; C08G 18/022; C08G 18/1875; C08G 18/165; C08J 9/141; C08J 9/125; C08G 2115/02; C08G 2110/0025; C08J 2203/182; C08J 2205/10; C08J 2375/06

(57) ABSTRACT

The present invention provides compositions having a phase transfer trimer catalyst and methods to produce polyisocyanurate/polyurethane foam using such compositions.

### FIELD OF THE INVENTION

The present invention relates compositions comprising catalyst systems, polyisocyanurate/polyurethane (PIR/PUR) foam formulations, and methods of making PIR/PUR foams.

### BACKGROUND OF THE INVENTION

Typically, polyisocyanurate/polyurethane (PIR/PUR) foams are made by reacting a polyol and a polyisocyanate in the presence of a catalyst. Additional additives can be present. PIR/PUR foam products have excellent thermal stability and flame resistance. Isocyanurates retain their strength to temperatures of about 160° C. and are resistant to most organic solvents, acids, alkali, ultraviolet light, and humidity.

Certain carboxylate salts, such as, for example, alkali metal carboxylate salts, have been used as catalysts in the production of PIR/PUR foams. The use of commercially available alkali metal carboxylate salt catalysts, however, often leads to undesirable foam processing problems which are particularly significant in continuous foam operations. A distinctive “step” is observed, which is normally associated with the onset of the trimerization process, when measuring the rise speed profile of a PIR/PUR foaming mixture. This “step” is evident when plotting the PIR/PUR foam height versus time. This trimerization “step” causes a significant change in the speed of the foam rise; in essence, the foam expands at two different rates during the foaming process. In a continuous polyisocyanurate/polyurethane foam lamination operation, it is difficult to adjust the speed of the production unit to match the change in the speed of the foam rise. The result can be foam overpacking or foam back flow. This undesirable rapid rise in foam height is particularly troublesome when processing polyisocyanurate/polyurethane formulations at a high Isocyanate Index. The reason being that the change in the rate of foam rise is much more dramatic at a higher isocyanate index. Consequently, it is a technical challenge to produce desirable low flammability foam products, with a high isocyanate index, when using conventional alkali metal carboxylate salt catalysts.

As compared to alkali metal carboxylate salt catalysts, commercially available polyisocyanurate trimerization catalysts based on hydroxyalkylammonium carboxylate salts show different processability in continuous operations. They provide a smoother rate of rise profile and have a less significant trimerization “step.” That is, the rate of foam rise is more consistent, even at a higher isocyanate index. However, commercial hydroxyalkylammonium carboxylate salt catalysts such as trimethyl(2-hydroxypropyl)ammonium-2-ethylhexanoate can be unstable at temperatures above about 100° C., decomposing into volatile amine by-products such as trimethylamine imparting strong amine odor to the finished foam product. The polymerization reactions that produce PIR/PUR foam are highly exothermic, often leading to foam processing temperatures in excess of 100° C. Hence, hydroxyalkylammonium carboxylate salt catalysts can provide more predictable foam processability, but sometimes at the expense of a foam product with an undesirable amine odor.

Thus, there exists a need for a catalyst composition and a foam formulation that can offer a smooth rise profile—foam height versus time—for producing PIR/PUR foams in continuous operations. Further, there exists a need for a catalyst composition that performs well in foam formulations with a high isocyanate index (e.g., an index of about 100 to about 800). At the same time, such catalyst composition should provide equivalent or faster surface cure (faster tack free time as defined in the experimental examples) when compared to commercially available catalyst systems, such that the foam products made with the catalyst composition can have reduced surface friability (e.g., improved hardness) and enhanced surface adherence during the manufacture of finished products such as laminated foam panels. Optionally, depending upon the selection of the catalyst components, the catalyst composition can be thermally stable at the temperatures which PIR/PUR foams normally encounter during manufacturing, and produce foams that are substantially free of volatile amines and/or amine odors.

U.S. Pat. No. 4,503,226 relates to a process to synthesize polyisocyanurate compositions from organic polyisocyanates using a selection of quaternary ammonium carboxylic acid salts and carboxylic acid halides or anhydrides. The disclosure is focused on the synthesis of organic compounds having the isocyanurate functionality. Several compositions are disclosed including tetramethylammonium acetate, tetraethylammonium acetate, tetramethylammonium propionate, tetramethylammonium octanoate, tetramethylammonium 2-ethylhexanoate, tetrabutylammonium 2-ethylhexanoate, benzyltrimethylammonium acetate, phenyltrimethylammonium 2-ethylhexanoate, tetrabutylammonium benzoate and the like. However, the disclosure is focused on the synthesis of isocyanurate compounds and it is not related to methods to make PIR/PUR polymers or foamed polymers.

U.S. Pat. No. 4,771,025 relates to a catalyst system useful in the preparation of PIR/PUR rigid foams comprising: a) an alkali metal or tetralkylammonium carboxylate; b) a group IIA metal carboxylate and optionally c) an amine co-catalyst. Examples of acids that are used in the patent disclosure for the mixed-metal salt catalyst include hexanoic acid, 2-methylhexanoic acid, 2-ethylhexanoic acid, cyclohexyl-acetic acid, trimethylacetic acid, isovaleric acid and butyric acid. Examples of tetraalkylammonium salts include tetrabutylammonium salts. The method requires the use of group II A metal carboxylate salts such as calcium and strontium salt but other metals such as magnesium, zinc and barium salt are also included and the polymeric materials are expanded using chlorofluorocarbon blowing agent such as trichlorofluoromethane to make foam. The group IIA metal carboxylate salts are also more insoluble in typical organic solvents used in polyurethane applications and require the use of specialty solvents or aqueous media limiting the applicability of this approach.

U.S. Pat. No. 5,321,050 disclosed a method for producing a modified PIR foam by reacting an organic polyisocyanate, polyol and water in the presence of a trimerizing catalyst composed of a hydroxyalkyl quaternary ammonium compound and a carbodiimide catalyst composed of phosphorene oxide. The trimerization catalyst has the general formula (R¹R²R³N—CH₂—CHOH—R⁴)(OOC—R⁵) where R¹, R², R³ represent independently alkyl, aralkyl, cycloalkyl, allyl or hydroxyalkyl and R⁴ and R⁵ each represent independently a hydrogen atom, alkyl, phenyl, alkenyl, hydroxyalkyl or ketoalkyl groups. The method forms PIR foams without the need for blowing agents such as CFC, HCFC, HFC and methylenechloride and requires using water as blowing agent in the presence of a carbodiimide catalyst based on phosphorene oxide. Preferred examples of trimer catalysts included trimethyl-(2-hydroxypropyl) ammonium formate and trimethyl-(2-hydroxypropyl) ammonium 2-ethylhexanoate. In addition to the requirement for phosphorene oxide compounds the technology is best used in water-blown formulations that lead to the formation of foamed materials with a higher content of open cells which have a negative impact on thermal insulations.

U.S. Pat. No. 4,040,992 relates to a method to make PIR foam using N-hydroxyalkyl quaternary ammonium carboxylate salts with preferred catalysts N-hydroxypropyl-trimethylammonium salts of carboxylic acids such as those of formic, acetic, hexanoic and octanoic acids. For the quaternary ammonium salts various amines are listed including trimethylamine, N,N-dimethyl-N-(hydroxyethyl)-amine, N-benzyl-N,N-dimethylamine and others that can be reacted in the presence of a carboxylic acid with ethylene oxide or propylene oxide to yield the corresponding N,N-dimethyl-N-hydroxyalkyl-ammonium carboxylate salt. The catalysts are used in making foam blown with water and CFCs such as GENETRON®11SBA (monochloro trifluoro ethane) and Freon®11 (trichlorofluoromethane). These blowing agents are well known ozone depleting agents and their commercial use has been banned. The use of these catalysts in combination with chlorofluorocarbon based blowing agents are characterized for having very delayed tack free times that impacts the foam surface cure as well as its adhesion to substrates as shown in the experimental examples. Thus, these polyurethane foam formulations have multiple limitations such as environmental impact, delayed tack free time, slow surface cure and consequently poor adhesion that limits their applicability in manufacturing operations such as discontinuous mold-filling or continuous lamination operations where fast surface cure is needed.

U.S. Pat. No. 3,954,684 disclosed a catalyst combination for the trimerization of polyisocyanates to polyisocyanurates using a catalyst combination comprising a tertiary amine trimerization catalyst and a quaternary ammonium salt of an alkanoic acid. The catalysts are typically made by the neutralization of a carboxylic acid with a quaternary ammonium hydroxide. Examples of carboxylic acids are: formic, acetic, propionic, butyric, isobutyric, valeric, caproic, heptylic, caprylic, 2-methylhexanoic, 2-ethylhexanoic, neopentanoic and the like. Examples of quaternary ammonium hydroxides are: tetramethylammonium, tetraethylammonium, tetrabutylammonium, tetraoctylammonium, trimethylethylammonium, tributylethylammonium, triethylbutylammonium, benzyltrimethylammonium, dibenzyldimethylammonium, tribenzylmethylammonium and the like. The use of this catalyst combination allows for the foaming speed to be varied according to the needs without foam collapse. The typical foaming agents disclosed are CFCs such as trichlorofluoromethane. However, the use of these catalysts in the presence of the blowing agents described such as Freon®R11 provide delayed tack free times that affects foam surface cure, surface hardness and adhesion as shown in the experimental examples.

U.S. Pat. No. 5,470,889 relates to a method to make rigid, closed cell polyisocyanurate foam prepared by reacting a polyisocyanate and a polyester polyol or a mixture of a polyester polyol and at least one other isocyanate-reactive compound in the presence of 1) a hydrogen containing blowing agent and at least one co-blowing agent and 2) a catalyst mixture comprising i) a carboxylate salt of an alkali metal or an alkaline earth metal or their mixtures, ii) a tertiary amine and iii) a quaternary ammonium carboxylate salt wherein the mole ratio of carboxylate metal salt/tertiary amine is a value of less than about 2:1 and the total moles of quaternary ammonium carboxylate are less than the combined moles of the carboxylate metal salt and tertiary amine. The blowing agents recommended included partially halogenated hydrocarbons, ethers, and esters, hydrocarbons, ethers, esters, and the like. The usable hydrogen containing halocarbons are the HCFCs such as 1,1-dichoro-1-fluoroethane (HCFC-141b), 1,1-dichloro-2,2,2-trifluoroethane (HCFC-123), monochlorodifluoromethane (HCFC-22), 1-chloro-1,1-difluoroethane (HCFC-142b), 1,1-difluoroethane (HCFC-152a) and 1,1,1,2-tetrafluoroethane (HFC-134a). Other blowing agents can also be used according to the disclosure including water, air, nitrogen, carbon dioxide and other readily volatile organic substances and/or compounds which decompose to liberate gases. This invention teaches the use of various blowing agents but it requires: 1) a metal carboxylate salt where the metal is preferentially alkali or alkali earth (potassium, for example) in the presence of a tertiary amine and a quaternary ammonium salt such that the conditions of [RCO₂M]/[R₃N]<2 and [RCO₂Q]<[RCO₂M]+[R₃N]. However, the presence of metal carboxylate salt according to this ratio has the negative impact of inducing a trimerization step in the foam rise profile causing the foaming mass to rise at two different speeds during the polymer expansion causing issues such as foam overpacking in continuous operations and making processing in continuous lines more difficult.

U.S. Pat. No. 3,989,651 relates to a process for the preparation of polyisocyanurate spray foams using a catalyst combination comprising i) N,N-dimethylcyclohexylamine and ii) a tetra(lower alkyl)quaternary ammonium salt of an alkanoic acid. The catalyst combination allows for spraying of polyisocyanurate foam under conditions of low ambient temperature on cold substrates and to achieve good adhesion between foam and substrate. The quaternary ammonium salt is prepared by reacting the corresponding alkanoic acid with the appropriate quaternary ammonium hydroxide. The alkanoic acid is represented by the general formula R¹—CO₂H where R¹ represents hydrogen or a C₁₋₇ alkyl group while the quaternary hydroxide compound is represented by the general formula [R²]₄N⁺OH⁻ where R² represents hydrogen or a C₁₋₇ alkyl group and where R¹ and R² are the same or different. Foaming agent used is trichlorofluoromethane. The typical foaming agents disclosed are CFCs such as trichlorofluoromethane. However, the use of quaternary ammonium salts as sole catalyst in the presence of the blowing agents described including various CFCs provides delayed tack free times that affect foam surface cure, foam hardness and adhesion.

### BRIEF SUMMARY OF THE INVENTION

The present invention solves the previously identified problems with conventional catalyst and formulations disclosed in the prior art and provides novel formulations for producing a PIR/PUR foam comprising at least one anionic source in the form of a carboxylate anion in combination with at least one cationic source that is phase transfer trimer active where the at least one blowing agent is a hydrocarbon or a hydrofluorocarbon (HFC) or a hydrofluoroolefin (HFO) or a hydrochlorofluoroolefin (HCFO) or a hydrochlorofluorocarbon (HCFC) or formic acid or water and with the proviso that the at least one blowing agent is not a chlorofluorocarbon (CFC).

The resulting compositions and formulations comprise a phase transfer trimer active carboxylate salt able to provide PIR/PUR foamed materials with a high isocyanurate content.

Thus, the present invention relates to a method to make a PIR/PUR rigid foam which comprises contacting at least one polyisocyanate with a polyol premix, where the polyol premix comprises a polyol or polyol mixture, a catalyst composition comprising at least one phase transfer trimer catalyst, and at least one blowing agent with the proviso that the at least one blowing agent is not a chlorofluorocarbon. The at least one phase transfer trimer catalyst comprises:
a. a phase transfer trimer catalyst of a general formula A-CO₂⁻.⁺NR¹R²R³R⁴, where A=H and R¹, R², R³, and R⁴ are each independently methyl, ethyl, propyl, butyl or —CH₂—Ar and Ar is an aryl group and preferably —C₆H₅; or where A=H, R¹=—CH₂—CH₂OH or —CH₂—CH(OH)—CH₃, R²=—CH₂—Ar, and R³ and R⁴ are each independently methyl, ethyl, propyl or butyl and Ar is an aryl group and preferably —C₆H₅; when the blowing agent comprises formic acid; or
b. a phase transfer trimer catalyst of a general formula A-CO₂⁻.⁺NR¹R²R³R⁴, where A=H or methyl and preferably methyl, R¹=—CH₂—CH₂OH or —CH₂—CH(OH)—CH₃, R²=—CH₂—Ar and Ar is an aryl group and preferably —C₆H₅, and R³ and R⁴ are each independently methyl, ethyl, propyl or butyl; or where A=H or methyl, R¹ and R² and R³ are each independently methyl, ethyl, propyl or butyl, and R⁴=—CH₂—Ar and Ar is an aryl group and preferably —C₆H₅; or A=H or methyl and preferably methyl, and R¹, R², R³, and R⁴ are each independently a C₁-C₄ alkyl group, when the blowing agent comprises a C₅-hydrocarbon blowing agent; or
c. a phase transfer trimer catalyst of a general formula A-CO₂⁻.⁺NR¹R²R³R⁴ where A=ethyl and R¹, R², R³, and R⁴ are each independently methyl, ethyl, propyl, butyl or —CH₂—Ar and Ar is an aryl group and preferably —C₆H₅, when the blowing agent comprises a C₅-hydrocarbon blowing agent; or
d. a phase transfer trimer catalyst of a general formula A-CO₂⁻.⁺NR¹R²R³R⁴ where A=propyl and R¹, R², R³, and R⁴ are each independently methyl, ethyl, propyl, butyl or —CH₂—Ar and Ar is an aryl group and preferably —C₆H₅, when the blowing agent comprises a C₅-hydrocarbon blowing agent.

In another aspect, the present invention discloses a composition comprising the contact product of at least one active hydrogen-containing compound, a catalyst composition comprising at least one phase transfer trimer catalyst, and at least one blowing agent, with the proviso that the at least one blowing agent is not a chlorofluorocarbon (CFC). Further, the present invention also discloses a composition comprising the contact product of at least one polyisocyanate, at least one active hydrogen-containing compound, a catalyst composition comprising at least one phase transfer trimer catalyst comprising a primary hydroxyl group, a secondary hydroxyl group, a primary amine group, a secondary amine group, a urea group or an amide group, and at least one blowing agent, with the proviso that the at least one blowing agent is not a chlorofluorocarbon (CFC).

The present invention also provides a method for preparing polyisocyanurate/polyurethane (PIR/PUR) foam. This method comprises contacting at least one polyisocyanate with at least one active hydrogen-containing compound, in the presence of at least one blowing agent, with the proviso that the at least one blowing agent is not a CFC, and an effective amount of a catalyst composition comprising at least one phase transfer trimer catalyst.

The catalyst composition of the present invention offers a substantially consistent foam height rise versus time—even at a high isocyanate index—and it can provide delay in the cream time and surprisingly fast surface cure or shorter tack free time during the preparation of PIR/PUR foams relative to conventional carboxylate salts. In another aspect of the present invention, the catalyst composition can be thermally stable at standard foam processing temperatures, producing PIR/PUR foams which are substantially free of volatile amines and/or amine odors.

The various aspects and embodiments herein can be used alone or in combinations with each other.

### BRIEF SUMMARY OF THE DRAWINGS

FIG. 1 shows foam samples made with Dabco®K15 and Formulation A using pentane as blowing agent, and Dabco®K15 and Formulation E using Freon®R11 (trichlorofluoromethane) as blowing agent.

FIG. 2 shows foam samples made with Dabco®K15 and Formulation A using pentane as blowing agent, and Dabco®K15 and Formulation F using Freon®R11 (trichlorofluoromethane) as blowing agent.

FIG. 3 shows foam samples made with Dabco®K15 and Formulation A using pentane as blowing agent, and Dabco®K15 and Formulation G using Freon®R11 (trichlorofluoromethane) as blowing agent.

### DEFINITIONS

The following definitions are provided in order to aid those skilled in the art in understanding the detailed description of the present invention.
PIR—Polyisocyanurate.
PUR—Polyurethane.
Isocyanate Index—The actual amount of polyisocyanate used divided by the theoretically required stoichiometric amount of polyisocyanate required to react with all the active hydrogen in the reaction mixture, multiplied by 100. Also known as (Eq NCO/Eq of active hydrogen)×100.
pphp—parts by weight per hundred weight parts polyol.
DABCO® K15 catalyst from Evonik Corporation is a 70% solution of an alkali metal carboxylate salt, potassium 2-ethylhexanoate (also known potassium octoate), in diethylene glycol.
Polycat® 5 catalyst from Evonik Corporation is a urethane catalyst, known chemically as pentamethyldiethylenetriamine.
Freon® R11 chemical name is trichlorofluoromethane, a chlorofluorocarbon blowing agent responsible for depleting the ozone layer and currently banned for any commercial use.

### DETAILED DESCRIPTION OF THE INVENTION

The present invention is directed to a novel composition comprising at least one phase transfer trimer catalyst combined with a PUR/PIR system that uses a blowing agent, with the proviso that the blowing agent is not a CFC or a mixture of CFCs. This novel catalyst system can be used as a polyisocyanate trimerization catalyst system for producing polyisocyanurate/polyurethane (PIR/PUR) foams. Further, the present invention is also directed to novel compositions comprising the contact product of at least one active hydrogen-containing compound, at least one blowing agent, and a catalyst composition comprising at least one phase transfer trimer catalyst, with the proviso that the blowing agent is not a chlorofluorocarbon. Additionally, the present invention is directed to novel compositions comprising the contact product of at least one polyisocyanate, at least one blowing agent, and a catalyst composition comprising at least one phase transfer trimer catalyst, with the proviso that the blowing agent is not a chlorofluorocarbon. These novel compositions can be used together with additional components to produce PIR/PUR foams.

Also, the present invention provides a method for preparing a PIR/PUR foam which comprises contacting at least one polyisocyanate with at least one active hydrogen-containing compound in the presence of at least one blowing agent and an effective amount of a catalyst composition comprising at least one phase transfer trimer catalyst, with the proviso that the blowing agent is not a chlorofluorocarbon. Additionally, rigid PIR/PUR foams can be produced with the novel catalyst system and novel compositions of the present invention by several methods known within the art.

A catalyst composition comprising at least one phase transfer trimer catalyst can be used to trimerize isocyanates to produce isocyanurates. Preferably, any amount of the at least one phase transfer trimer catalyst can be used in the compositions of the present invention. As used in practice, catalyst systems for PIR/PUR foams typically include solutions of carboxylate salts in, for example, a diluent such as ethylene glycol, diethylene glycol, polyethylene glycol, dimethylsulfoxide (DMSO), pyrrolidone, propylene glycol, dipropylene glycol, and polypropylene glycol. Preferably, the amount of diluent can range from about 5% to about 90%, about 10% to about 80% and in some cases about 20% to about 70% wt. % of the catalyst. Thus, as an example, if 10 grams of a 50% solution of benzyltrimethylammonium acetate catalyst in ethylene glycol were used in a given application, the amount of the benzyltrimethylammonium acetate salt catalyst would equal 5 grams. Hence, 5 grams of that catalyst component would be used in calculating any weight ratios of that component in relation to, for example, the amount of active hydrogen-containing compound or the amount of polyol.

Several types of ranges are disclosed in the present invention. These include, but are not limited to, a range of temperatures; a range of number of atoms; a range of foam density; a range of isocyanate index; and a range of pphp for the blowing agent, water, surfactant, flame retardant, and catalyst composition comprising at least one phase transfer trimer catalyst. Each possible number that such a range could reasonably encompass, as well as any sub-ranges and combinations of sub-ranges encompassed therein are the subject of the present invention. For example, for a chemical moiety having a certain number of carbon atoms, every possible number that such a range could encompass, consistent with the disclosure herein are the subject of the present invention. For example, the disclosure that “R¹” can be an alkyl group having up to 18 carbon atoms, or in alternative language a C₁ to C₁₈ alkyl group, as used herein, refers to a “R¹” group that can be selected independently from an alkyl group having 1, 2, 3, 4, 5, 6, 7, 8, 9, 10, 11, 12, 13, 14, 15, 16, 17, or 18 carbon atoms, as well as any range between these two numbers (for example, a C₁ to C₈ alkyl group), and also including any combination of ranges between these two numbers (for example, a C₃ to C₅ and C₇ to C₁₀ alkyl group). Likewise, this applies to all other carbon ranges disclosed herein, for example, C₁ to C₁₈ ranges for R² and R³; alkoxy groups having up to 10 carbon atoms; etc.

Similarly, another representative example follows for the parts by weight of the catalyst composition comprising at least one phase transfer trimer catalyst per hundred weight parts of the at least one active hydrogen-containing compound in a composition or a foam formulation. If the at least one active hydrogen-containing compound is an at least one polyol, the parts by weight per hundred weight parts polyol is abbreviated as pphp. Hence, by the disclosure that the catalyst composition comprising at least one phase transfer trimer catalyst is present in an amount from about 0.05 to about 10 pphp, for example, the pphp can preferably be selected from about 0.05, about 0.06, about 0.07, about 0.08, about 0.09, about 0.1, about 0.2, about 0.3, about 0.4, about 0.5, about 0.6, about 0.7, about 0.8, about 0.9, about 1, about 2, about 3, about 4, about 5, about 6, about 7, about 8, about 9, or about 10. Likewise, all other ranges disclosed herein should be interpreted in a manner similar to these two examples.

Any individual members of any such group, including any sub-ranges or combinations of sub-ranges within the group may be excluded. Further, any individual substituents, analogs, compounds, ligands, structures, or groups thereof, or any members of a claimed group may be excluded.

Another aspect of the present invention also provides a thermally stable catalyst system. When used to describe this feature, a compound is defined as thermally stable at a given temperature when it does not decompose or release volatile amines and/or related amine odors at the given temperature. Certain features of the inventive catalyst composition are thermally stable up to a temperature of about 120° C. In a further aspect, the catalyst system of the present invention has thermal stability up to about 175° C., about 200° C., about 220° C., about 240° C., or about 250° C.

In one aspect of the invention, preferably the phase transfer trimer catalyst comprises at least one member selected from the group consisting of salts with thermal stability including but not limited to tetramethylammonium formate, tetramethylammonium acetate, tetraethylammonium formate, tetraethylammonium acetate, tetrapropylammonium formate, tetrapropylammonium acetate, tetrabutylammonium formate, tetrabutylammonium acetate, benzyltrimethylammonium formate, benzyltrimethylammonium acetate, tetramethylammonium propionate, tetramethylammonium butyrate, tetraethylammonium propionate, tetraethylammonium butyrate, tetrapropylammonium propionate, tetrapropylammonium butyrate, tetrabutylammonium propionate, tetrabutylammonium butyrate, benzyltrimethylammonium propionate, benzyltrimethylammonium butyrate, benzyltrimethylammonium pivalate, benzyl-(2-hydroxypropyl)-dimethylammonium acetate, benzyl-(2-hydroxypropyl)-dimethylammonium formate, benzyl-(2-hydroxyethyl)-dimethylammonium acetate, benzyl-(2-hydroxyethyl)-dimethylammonium formate, benzyl-(2-hydroxypropyl)-dimethylammonium propionate, benzyl-(2-hydroxypropyl)-dimethylammonium butyrate, benzyl-(2-hydroxypropyl)-dimethylammonium pentanoate, benzyl-(2-hydroxypropyl)-dimethylammonium hexanoate, benzyl-(2-hydroxypropyl)-dimethylammonium heptanoate, benzyl-(2-hydroxypropyl)-dimethylammonium octanoate, benzyl-(2-hydroxypropyl)-dimethylammonium 2-ethylhexanoate and the like. Such salts can be employed individually or in any combination thereof.

The phase transfer trimer catalyst can preferably be used in combination with a tertiary amine. The tertiary amine can preferably be a conventional tertiary amine such as triethylenediamine (TEDA), N-methylimidazole, 1,2-dimethyl-imidazole, N-methylmorpholine (commercially available as DABCO® NMM), N-ethylmorpholine (commercially available as DABCO® NEM), triethylamine (commercially available as DABCO® TETN), N,N′-dimethylpiperazine, 1,3,5-tris(dimethylaminopropyl)hexahydrotriazine (commercially available as Polycat® 41), 2,4,6-tris(dimethylaminomethyl)phenol (commercially available as DABCO TMR® 30), N-methyldicyclohexylamine (commercially available as Polycat® 12), pentamethyldipropylene triamine (commercially available as Polycat® 77), N-methyl-N′-(2-dimethylamino)-ethyl-piperazine, tributylamine, pentamethyl-diethylenetriamine (commercially available as Polycat® 5), hexamethyl-triethylenetetramine, heptamethyltetraethylenepentamine, dimethylaminocyclohexyl-amine (commercially available as Polycat® 8), triethanolamine, dimethylethanolamine, bis(dimethylaminoethyl)ether (commercially available as DABCO® BL19), tris(3-dimethylaminopropyl)amine (commercially available as Polycat® 9), 1,8-diazabicyclo[5.4.0] undecene (commercially available as DABCO® DBU) or its acid blocked derivatives, and the like, as well as any mixture thereof. Particularly useful as a urethane catalyst for foam applications related to the present invention is Polycat® 5, which is known chemically as pentamethyldiethylenetriamine. The phase transfer trimer catalysts can also be used with tertiary amines having at least one isocyanate reactive group comprising a primary hydroxyl group, a secondary hydroxyl group, a primary amine group, a secondary amine group, a urea group or an amide group. Preferred examples of a tertiary amine catalyst having an isocyanate group include, but are not limited to N, N-bis(3-dimethylaminopropyl)-N-isopropanolamine, N, N-dimethylaminoethyl-N′-methyl ethanolamine, N, N, N′-trimethylaminopropylethanolamine, N, N-dimethylethanolamine, N, N-diethylethanolamine, N, N-dimethyl-N′, N′-(2-hydroxypropyl)-1, 3-propylenediamine, dimethylaminopropylamine, (N, N-dimethylaminoethoxy) ethanol, N-methyl-N′-(2-hydroxyethyl)-piperazine, bis(N, N-dimethyl-3-aminopropyl) amine, N, N-dimethylaminopropyl urea, N, N-diethylaminopropyl urea, N, N′-bis(3-dimethylaminopropyl)urea, bis(dimethylamino)-2-propanol, 6-dimethylamino-1-hexanol, N-(3-aminopropyl) imidazole), N-(2-hydroxypropyl) imidazole, and N-(2-hydroxyethyl) imidazole, 2-[N-(dimethylaminoethoxyethyl)-N-methylamino]ethanol, N, N-dimethylaminoethyl-N′-methyl-N′-ethanol, dimethylaminoethoxyethanol, N, N, N′-trimethyl-N′-3-aminopropyl-bis(aminoethyl) ether, or a combination thereof.

Tertiary amines used in combination with the phase transfer trimer catalyst can also be acid blocked with an acid including carboxylic acids (alkyl, substituted alkyl, alkylene, aromatic, substituted aromatic) sulfonic acids or any other organic or inorganic acid. Preferred examples of carboxylic acids include mono-acids, di-acids or poly-acids with or without isocyanate reactive groups. Preferred examples of carboxylic acids include formic acid, acetic acid, propionic acid, butanoic acid, pentanoic acid, neopentanoic acid, hexanoic acid, 2-ethylhexyl carboxylic acid, neohexanoic acid, octanoic acid, neooctanoic acid, heptanoic acid, neoheptanoic acid, nonanoic acid, neononanoic acid, decanoic acid, neodecanoic acid, undecanoic acid, neoundecanoic acid, dodecanoic acid, neododecanoic acid, myristic acid, pentadecanoic acid, hexadecanoic acid, heptadecanoic acid, octadecanoic acid, benzoic acid, oxalic acid, malonic acid, succinic acid, glutaric acid, adipic acid, pimelic acid, suberic acid, azelaic acid, sebacic acid, glycolic acid, lactic acid, tartaric acid, citric acid, malic acid, salicylic acid and the like.

In one aspect of the present invention, the catalyst composition comprises at least one phase transfer trimer catalyst that has thermal stability up to about 150° C., wherein no or substantially no volatile amine compounds are emitted. Typical foam temperatures resulting from the exothermic reactions during the processing of PIR/PUR foam can be in the range of about 80° C. to about 150° C. In a further aspect, the catalyst system of the present invention has thermal stability up to about 175° C., about 200° C., about 220° C., about 240° C., or about 250° C.

The phase transfer trimer catalyst can be produced, for example, by the reaction of an organic acid with an alkali hydroxide. In another aspect of the present invention, the phase transfer trimer catalyst can be produced by the reaction of an organic acid with a tetraalkylammonium hydroxide, or a reaction of an organic acid with a tertiary amine followed by a reaction with an epoxy compound. Alternatively, the phase transfer trimer catalyst can be produced, for example, by the reaction of a tertiary amine with an alkylhalide or an arylalkylhalide to make a quaternary ammonium halide that is subsequently treated with an akali or alkali earth hydroxide to give the corresponding phase transfer trimer catalyst. The reaction of an organic acid with a tertiary amine followed by reaction with an epoxy can lead to a hydroxyalkyl quaternary compound such as benzyl-(2-hydroxypropyl)dimethyl-ammonium salt.

Preferred examples of the phase transfer trimer catalyst salts include, but are not limited to, tetramethylammonium formate, tetramethylammonium acetate, tetraethylammonium formate, tetraethylammonium acetate, tetrapropylammonium formate, tetrapropylammonium acetate, tetrabutylammonium formate, tetrabutylammonium acetate, benzyltrimethylammonium formate, benzyltrimethylammonium acetate, tetramethylammonium propionate, tetramethylammonium butyrate, tetraethylammonium propionate, tetraethylammonium butyrate, tetrapropylammonium propionate, tetrapropylammonium butyrate, tetrabutylammonium propionate, tetrabutylammonium butyrate, benzyltrimethylammonium propionate, benzyltrimethylammonium butyrate, benzyltrimethylammonium pivalate, benzyl-(2-hydroxypropyl)-dimethylammonium acetate, benzyl-(2-hydroxypropyl)-dimethylammonium formate, benzyl-(2-hydroxyethyl)-dimethylammonium acetate, benzyl-(2-hydroxyethyl)-dimethylammonium formate, benzyl-(2-hydroxypropyl)-dimethylammonium propionate, benzyl-(2-hydroxypropyl)-dimethylammonium butyrate, benzyl-(2-hydroxypropyl)-dimethylammonium pentanoate, benzyl-(2-hydroxypropyl)-dimethylammonium hexanoate, benzyl-(2-hydroxypropyl)-dimethylammonium heptanoate, benzyl-(2-hydroxypropyl)-dimethylammonium octanoate, benzyl-(2-hydroxypropyl)-dimethylammonium 2-ethylhexanoate and the like, or any combination thereof.

The amount of the other catalytic materials and salts can range from about 0.01 pphp to about 20 pphp, about 0.1 pphp to about 15 pphp and in some cases about 0.5 pphp to about 10 pphp.

It is also within the scope of the catalyst composition of this invention to include mixtures or combinations of more than one phase transfer trimer catalyst. Additionally, the catalyst system or the novel compositions of the present invention can also further comprise at least one urethane catalyst having no isocyanate reactive groups.

The term “contact product” is used herein to describe compositions wherein the components are contacted together in any order, in any manner, and for any length of time. For example, the components can be contacted by blending or mixing. Further, contacting of any component can occur in the presence or absence of any other component of the compositions or foam formulations described herein. Combining additional catalyst components can be done by any method known to one of skill in the art. For example, in one aspect of the present invention, catalyst compositions can be prepared by combining or contacting the at least one phase transfer trimer catalyst with an alkali metal carboxylate salt. This typically occurs in solution form. In another aspect, the catalyst composition can be prepared by first mixing the respective carboxylic acids, followed by neutralization to form the corresponding salts followed by combining or contacting with a tertiary amine catalyst having at least one isocyanate reactive group.

While compositions and methods are described in terms of “comprising” various components or steps, the compositions and methods can also “consist essentially of” or “consist of” the various components or steps.

### Phase Transfer Trimer Catalysts

Catalyst compositions of the present invention comprise at least one phase transfer trimer catalyst. The at least one phase transfer trimer catalyst is particularly useful for producing PIR/PUR foams. Thus, the present invention relates to a method to make a PIR/PUR rigid foam which comprises contacting at least one polyisocyanate with a polyol premix, where the polyol premix comprises a polyol or polyol mixture, a catalyst composition comprising at least one phase transfer trimer catalyst, and a blowing agent with the proviso that the at least one blowing agent is not a chlorofluorocarbon.

In one embodiment, preferably the at least one phase transfer trimer catalyst has the general formula A-CO₂⁻.⁺NR¹R²R³R⁴, where A=H and R¹, R², R³, and R⁴ are each independently methyl, ethyl, propyl, butyl or —CH₂—Ar and Ar is an aryl group and preferably —C₆H₅; or where A=H, R¹=—CH₂—CH₂OH or —CH₂—CH(OH)—CH₃, R²=—CH₂—Ar, and R³ and R⁴ are each independently methyl, ethyl, propyl or butyl and Ar is an aryl group and preferably —C₆H₅; when the blowing agent comprises formic acid.

In another embodiment, preferably the at least one phase transfer trimer catalyst has the general formula A-CO₂⁻.⁺NR¹R²R³R⁴, where A=H or methyl and preferably methyl, R¹=—CH₂—CH₂OH or —CH₂—CH(OH)—CH₃, R²=—CH₂—Ar and Ar is an aryl group and preferably —C₆H₅, and R³ and R⁴ are each independently methyl, ethyl, propyl or butyl; or where A=H or methyl, R¹ and R² and R³ are each independently methyl, ethyl, propyl or butyl, and R⁴=—CH₂—Ar and Ar is an aryl group and preferably —C₆H₅; or where A=H or methyl and preferably methyl, and R¹, R², R³, and R⁴ are each independently a C₁-C₄ alkyl group; when the blowing agent comprises a C₅-hydrocarbon blowing agent.

In another embodiment, preferably the at least one phase transfer trimer catalyst has the general formula A-CO₂⁻.⁺NR¹R²R³R⁴ where A=ethyl and R¹, R², R³, and R⁴ are each independently methyl, ethyl, propyl, butyl or —CH₂—Ar and Ar is an aryl group and preferably —C₆H₅, when the blowing agent comprises a C₅-hydrocarbon blowing agent.

In another embodiment, preferably the at least one phase transfer trimer catalyst has the general formula A-CO₂⁻.⁺NR¹R²R³R⁴ where A=propyl and R¹, R², R³, and R⁴ are each independently methyl, ethyl, propyl, butyl or —CH₂—Ar and Ar is an aryl group and preferably —C₆H₅, when the blowing agent comprises a C₅-hydrocarbon blowing agent.

Unless otherwise specified, alkyl and alkenyl groups described herein are intended to include all structural isomers, linear or branched, of a given structure; for example, all enantiomers and all diasteriomers are included within this definition. As an example, unless otherwise specified, the term propyl is meant to include n-propyl and iso-propyl, while the term butyl is meant to include n-butyl, iso-butyl, t-butyl, sec-butyl, and so forth. Similarly, substituted alkyl, alkenyl, aryl, and aralkyl groups described herein are intended to include substituted analogs of a given structure. For example, the substituents on alkyl, alkenyl, aryl, and aralkyl groups can include, but are not limited to, halides; hydroxyl groups; amino groups; alkoxy, alkylamino, or dialkylamino groups having up to 10 carbon atoms; or combinations thereof.

Non-limiting examples of alkyl groups which can be present in the at least one phase transfer trimer catalyst preferably include, but are not limited to, methyl, ethyl, propyl, butyl, pentyl, hexyl, and the like. Examples of alkenyl groups within the scope of the present invention preferably include, but are not limited to, ethenyl, propenyl, butenyl, pentenyl, hexenyl, heptenyl, octenyl, nonenyl, decenyl, and the like. Aryl and aralkyl (aralkyl is defined as an aryl-substituted alkyl or arylalkyl) groups preferably include phenyl, alkyl-substituted phenyl, naphthyl, alkyl-substituted naphthyl, and the like. For example, non-limiting examples of aryl and aralkyl groups useful in the present invention preferably include, but are not limited to, phenyl, tolyl, benzyl, dimethylphenyl, trimethylphenyl, phenylethyl, phenylpropyl, phenylbutyl, propyl-2-phenylethyl, and the like.

In one aspect of the present invention, R¹, R², R³, and R⁴ are selected independently from methyl, ethyl, propyl, butyl and benzyl. In another aspect, R¹, R², R³, and R⁴ are selected independently from methyl, ethyl, propyl, and butyl.

In another aspect, the quaternary ammonium ions useful in the present invention preferably include, but are not limited to, tetramethylammonium, tetraethylammonium, tetrapropylammonium, tetrabutylammonium, dimethyldiallylammonium, benzyltrimethylammonium, di(benzyl)dimethylammonium, triethyl(2-hydroxypropyl)ammonium, tripropyl(2-hydroxypropyl)ammonium, tributyl(2-hydroxypropyl)ammonium, triethyl(2-hydroxyethyl)ammonium, tripropyl(2-hydroxyethyl)ammonium, tributyl(2-hydroxyethyl)ammonium, dimethylbenzyl(2-hydroxypropyl)ammonium, dimethylbenzyl(2-hydroxyethyl)ammonium, and the like, or any combination thereof.

In another aspect of the present invention, the at least one phase transfer trimer catalyst used in combination with at least one tertiary amine having at least one isocyanate reactive group is an alkali metal carboxylate salt or a quaternary ammonium carboxylate salt, or a combination thereof.

The selection of the suitable phase transfer trimer catalysts of the present invention must be done according to the type of blowing agent used. Preferred examples of phase transfer trimer catalysts when the blowing agent is formic acid include tetramethylammonium formate, tetraethylammonium formate, tetrapropylammonium formate, tetrabutylammonium formate, benzyltrimethylammonium formate, benzyldimethyl-(2-hydroxypropyl) ammonium formate and benzyldimethyl-(2-hydroxyethyl) ammonium formate. Preferred examples of phase transfer trimer catalysts when the blowing agent is a C₅-hydrocarbon include tetramethylammonium acetate, tetraethylammonium acetate, tetrapropylammonium acetate, tetrabutylammonium acetate, tetrabutylammonium formate, benzyltrimethylammonium formate, benzyltrimethylammonium acetate, benzyldimethyl-(2-hydroxypropyl) ammonium acetate and benzyldimethyl-(2-hydroxyethyl) ammonium acetate.

In another aspect of the present invention, the at least one phase transfer trimer catalyst used in combination with at least one tertiary amine having at least one isocyanate reactive group is a tetraalkylammonium carboxylate salt. In another aspect, the at least one phase transfer trimer catalyst used in combination with at least one tertiary amine having at least one isocyanate reactive group is benzyldimethyl-(2-hydroxypropyl) ammonium formate when the blowing agent is formic acid. In another aspect, the at least one phase transfer trimer catalyst used in combination with at least one tertiary amine having at least one isocyanate reactive group is benzyldimethyl-(2-hydroxypropyl) ammonium acetate when the blowing agent is a C₅-hydrocarbon.

In a further aspect, the at least one phase transfer trimer catalyst used in combination with at least one tertiary amine having at least one isocyanate reactive group is a salt of a carboxylic acid, for example, a quaternary ammonium salt of a carboxylic acid. Suitable carboxylic acids within the scope of the present invention preferably include, but are not limited to, formic, acetic, propionic, butanoic, pentanoic, neopentanoic or pivalic, triethylacetic, hexanoic, neohexanoic, heptanoic, neoheptanoic, octanoic, neooctanoic, decanoic, neodecanoic, undecanoic, neoundecanoic, dodecanoic, neododecanoic, and the like, mixtures thereof, or any combination thereof but preferably formic and acetic.

In a further aspect, the phase transfer trimer catalyst is used in combination with at least one tertiary amine having at least one isocyanate reactive group comprising a primary hydroxyl group, a secondary hydroxyl group, a primary amine group, a secondary amine group, a urea group or an amide group. Preferred examples of a tertiary amine catalyst having an isocyanate group include, but are not limited to N, N-bis(3-dimethylaminopropyl)-N-isopropanolamine, N, N-dimethylaminoethyl-N′-methyl ethanolamine, N, N, N′-trimethylaminopropylethanolamine, N, N-dimethylethanolamine, N, N-diethylethanolamine, N, N-dimethyl-N′, N′-(2-hydroxypropyl)-1, 3-propylenediamine, dimethylaminopropylamine, (N, N-dimethylaminoethoxy) ethanol, N-methyl-N′-hydroxy-ethyl-piperazine, bis(N, N-dimethyl-3-aminopropyl) amine, N, N-dimethylaminopropyl urea, diethylaminopropyl urea, N, N′-bis(3-dimethylaminopropyl)urea, N, N′-bis(3-diethylaminopropyl)urea, bis(dimethylamino)-2-propanol, 6-dimethylamino-1-hexanol, N-(3-aminopropyl)-imidazole, N-(2-hydroxypropyl) imidazole, and N-(2-hydroxyethyl) imidazole, 2-[N-(dimethylaminoethoxyethyl)-N-methylamino] ethanol, N, N-dimethylaminoethyl-N′-methyl-N′-ethanol, dimethylaminoethoxyethanol, N, N, N′-trimethyl-N′-3-aminopropyl-bis(aminoethyl) ether, or a combination thereof.

### Polyisocyanates

Polyisocyanates that are useful in the PIR/PUR foam formation process preferably include, but are not limited to, hexamethylene diisocyanate, isophorone diisocyanate, phenylene diisocyante, toluene diisocyanate (TDI), diphenyl methane diisocyanate isomers (MDI), hydrated MDI and 1,5-naphthalene diisocyanate. For example, 2,4-TDI, 2,6-TDI, and mixtures thereof, can be readily employed in the present invention. Preferred examples of polyisocyanates include toluene diisocyanate and diphenyl methane diisocyanate and their isomers. Other suitable mixtures of diisocyanates include, but are not limited to, those known in the art as crude MDI, or PAPI, which contain 4,4′-diphenylmethane diisocyanate along with other isomeric and analogous higher polyisocyanates. In another aspect of this invention, prepolymers of polyisocyanates comprising a partially pre-reacted mixture of polyisocyanates and polyether or polyester polyol are suitable. In still another aspect, the polyisocyanate comprises MDI, or consists essentially of MDI or mixtures of MDI's.

The catalyst system, compositions, and methods of producing PIR/PUR foam of the present invention can be used to manufacture many types of foam. This catalyst system is useful, for example, in the formation of foam products for rigid and flame retardant applications, which usually require a high isocyanate index. As defined previously, isocyanate index is the actual amount of polyisocyanate used divided by the theoretically required stoichiometric amount of polyisocyanate required to react with all the active hydrogen in the reaction mixture, multiplied by 100. For purposes of the present invention, isocyanate index is represented by the equation: Isocyanate Index=(Eq NCO/Eq of active hydrogen)×100, wherein Eq NCO is the number of NCO functional groups in the polyisocyanate, and Eq of active hydrogen is the number of equivalent active hydrogen atoms.

Foam products which are produced with an Isocyanate Index from about 80 to about 800 are within the scope of this invention. In accordance with other aspects of the present invention, the Isocyanate Index ranges from about 100 to about 700, from about 150 to about 800, from about 200 to about 600, or from about 250 to about 500.

### Polyols

Active hydrogen-containing compounds for use with the foregoing polyisocyanates in forming the polyisocyanurate/polyurethane foams of this invention can be any of those organic compounds having at least two hydroxyl groups such as, for example, polyols. Polyols that are typically used in PIR/PUR foam formation processes preferably include polyalkylene ether and polyester polyols. The polyalkylene ether polyol includes the poly(alkyleneoxide) polymers such as poly(ethyleneoxide) and poly(propyleneoxide) polymers and copolymers with terminal hydroxyl groups derived from polyhydric compounds, including diols and triols, These preferably include, but are not limited to, ethylene glycol, propylene glycol, 1,3-butane diol, 1,4-butane diol, 1,6-hexane diol, neopentyl glycol, diethylene glycol, dipropylene glycol, pentaerythritol, glycerol, diglycerol, trimethylol propane, cyclohexane diol, and sugars such as sucrose and like low molecular weight polyols.

Amine polyether polyols can be used in the present invention. These can be prepared when an amine such as, for example, ethylenediamine, diethylenetriamine, tolylenediamine, diphenylmethanediamine, or triethanolamine is reacted with ethylene oxide or propylene oxide.

In another aspect of the present invention, a single high molecular weight polyether polyol, or a mixture of high molecular weight polyether polyols, such as mixtures of different multifunctional materials and/or different molecular weight or different chemical composition materials can be used.

In yet another aspect of the present invention, polyester polyols can be used, including those produced when a dicarboxylic acid is reacted with an excess of a diol. Non-limiting examples include adipic acid or phathalic acid or phthalic anhydride reacting with ethylene glycol or butanediol. Polyols useful in the present invention can be produced by reacting a lactone with an excess of a diol, for example, caprolactone reacted with propylene glycol. In a further aspect, active hydrogen-containing compounds such as polyester polyols and polyether polyols, and combinations thereof, are useful in the present invention.

The polyol can have an OH number of about 5 to about 600, about 100 to about 600 and in some cases about 50 to about 100 and a functionality of about 2 to about 8, about 3 to about 6 and in some cases about 4 to about 6.

The amount of polyol can range from about 0 pphp to about 100 pphp about 10 pphp to about 90 pphp and in some cases about 20 pphp to about 80 pphp.

### Blowing Agents

In accordance with the compositions, foam formulations, and methods of producing PIR/PUR foam within the scope of the present invention, suitable blowing agents that can be used alone or in combination preferably include, but are not limited to, hydrocarbons, formic acid, water, hydrofluorocarbons (HFCs), hydrofluoroolefins (HFOs), hydrofluorochloroolefins (HFCOs), hydrochlorofluorocarbons (HCFCs) and formates. Preferred examples of HFCs include, but are not limited to, HFC-245fa, HFC-134a, and HFC-365. Preferred examples of HCFCs include, but are not limited to, HCFC-141b, HCFC-22, and HCFC-123. Preferred examples of hydrocarbons include, but are not limited to, n-pentane, iso-pentane, cyclopentane, and the like, or any combination thereof. In one aspect of the present invention, the blowing agent or mixture of blowing agents comprises at least one hydrocarbon. In another aspect, the blowing agent comprises n-pentane. Yet, in another aspect of the present invention, the blowing agent consists essentially of n-pentane or mixtures of n-pentane with one or more blowing agents. In another aspect, the blowing agent comprises cyclopentane. Yet, in another aspect of the present invention, the blowing agent consists essentially of cyclopentane or mixtures of cyclopentane with one or more blowing agents. In another aspect, the blowing agent comprises mixtures of n-pentane and cyclopentane. Yet, in another aspect of the present invention, the blowing agent consists essentially of mixtures of n-pentane and cyclopentane with one or more blowing agents. In another aspect, the blowing agent comprises any isomeric pentane mixture. Yet, in another aspect of the present invention, the blowing agent consists essentially of any isomeric pentane mixture with one or more blowing agents.

Preferred examples of hydrohaloolefin blowing agents are HFO-1234ze (trans-1,3,3,3-Tetrafluoroprop-1-ene), HFO-1234yf (2,3,3,3-Tetrafluoropropene) and HFCO-1233zd (1-Propene,1-chloro-3,3,3-trifluoro), among other HFOs.

Due to the discovery that chlorofluorocarbons (CFCs) can deplete ozone in the stratosphere, this class of blowing agents is not desirable for use in the present invention. In addition, the CFC blowing agents also present performance disadvantages as shown in the experimental examples. A chlorofluorocarbon (CFC) is an alkane in which all hydrogen atoms are substituted with chlorine and fluorine atoms. Examples of CFCs include trichlorofluoromethane and dichlorodifluoromethane. Thus, compositions in accordance with the present invention comprise only non-CFC blowing agents.

The amount of blowing agent used can vary based on, for example, the intended use and application of the foam product and the desired foam stiffness and density. In the compositions, foam formulations and methods for preparing a polyisocyanurate/polyurethane foam of the present invention, the blowing agent is present in amounts from about 0.5 to about 80 parts by weight per hundred weight parts of the at least one active hydrogen-containing compound. In another aspect, the blowing agent is present in amounts from about 1 to about 60, from about 4 to about 50, or from about 8 to about 40, parts by weight per hundred weight parts of the at least one active hydrogen-containing compound. If the at least one active hydrogen-containing compound is an at least one polyol, the blowing agent is present in amounts from about 0.5 to about 80 parts by weight per hundred weight parts polyol (pphp), from about 4 to about 60 pphp, from about 8 to about 50 pphp, or from about 10 to about 40 pphp.

If water is present in the formulation, for use as a blowing agent or otherwise, water is present in amounts up to about 15 parts by weight per hundred weight parts of the at least one active hydrogen-containing compound. Likewise, if the at least one active hydrogen-containing compound is an at least one polyol, water can range from 0 to about 15 pphp. In another aspect, water can range from 0 to about 10 pphp, from 0 to about 8 pphp, from 0 to about 6 pphp, or from 0 to about 4 pphp.

### Urethane Catalyst

Conventional urethane catalysts having no isocyanate reactive group can be employed to accelerate the reaction to form polyurethanes, and can be used as a further component of the catalyst systems and compositions of the present invention to produce polyisocyanurate/polyurethane foam. Urethane catalysts suitable for use herein preferably include, but are not limited to, metal salt catalysts, such as organotins, and amine compounds, such as triethylenediamine (TEDA), N-methylimidazole, 1,2-dimethyl-imidazole, N-methylmorpholine (commercially available as the DABCO® NMM catalyst), N-ethylmorpholine (commercially available as the DABCO® NEM catalyst), triethylamine (commercially available as the DABCO® TETN catalyst), N,N′-dimethylpiperazine, 1,3,5-tris(dimethylaminopropyl)hexahydrotriazine (commercially available as the Polycat® 41 catalyst), 2,4,6-tris(dimethylaminomethyl)phenol (commercially available as the DABCO TMR® 30 catalyst), N-methyldicyclohexylamine (commercially available as the Polycat® 12 catalyst), pentamethyldipropylene triamine (commercially available as the Polycat® 77 catalyst), N-methyl-N′-(2-dimethylaminoethyl)-piperazine, tributylamine, pentamethyl-diethylenetriamine (commercially available as the Polycat® 5 catalyst), hexamethyl-triethylenetetramine, heptamethyltetraethylenepentamine, dimethylaminocyclohexyl-amine (commercially available as the Polycat® 8 catalyst), pentamethyldipropylene-triamine, triethanolamine, dimethylethanolamine, bis(dimethylaminoethyl)ether (commercially available as the DABCO® BL19 catalyst), bis(morpholinoethyl)ether also known as di-morpholino-diethyl ether or DMDEE, tris(3-dimethylaminopropyl)amine (commercially available as the Polycat® 9 catalyst), 1,8-diazabicyclo[5.4.0] undecene (commercially available as the DABCO® DBU catalyst) or its acid blocked derivatives, and the like, as well as any mixture thereof. Particularly useful as a urethane catalyst for foam applications related to the present invention is the Polycat® 5 catalyst, which is known chemically as pentamethyldiethylenetriamine.

Other urethane catalysts with at least one tertiary amine having at least one isocyanate reactive group comprising a primary hydroxyl group, a secondary hydroxyl group, a primary amine group, a secondary amine group, a urea group or an amide group can also be used. Preferred examples of tertiary amine catalysts having an isocyanate group include, but are not limited to N, N-bis(3-dimethylaminopropyl)-N-isopropanolamine, N, N-dimethylaminoethyl-N′-methyl ethanolamine, N, N, N′-trimethylaminopropylethanolamine, N, N-dimethylethanolamine, N, N-diethylethanolamine, N, N-dimethyl-N′, N′-(2-hydroxypropyl)-1, 3-propylenediamine, dimethylaminopropylamine, (N, N-dimethylaminoethoxy) ethanol, N-methyl-N′-hydroxy-ethyl-piperazine, bis(N, N-dimethyl-3-aminopropyl) amine, N, N-dimethylaminopropyl urea, diethylaminopropyl urea, N, N′-bis(3-dimethylaminopropyl)urea, N, N′-bis(3-diethylaminopropyl)urea, bis(dimethylamino)-2-propanol, 6-dimethylamino-1-hexanol, N-(3-aminopropyl)-imidazole, N-(2-hydroxypropyl) imidazole, and N-(2-hydroxyethyl) imidazole, 2-[N-(dimethylaminoethoxyethyl)-N-methylamino] ethanol, N, N-dimethylaminoethyl-N′-methyl-N′-ethanol, dimethylaminoethoxyethanol, N, N, N′-trimethyl-N′-3-aminopropyl-bis(aminoethyl) ether, or a combination thereof.

For preparing a polyisocyanurate/polyurethane foam of the present invention, the urethane catalyst can be present in the formulation from 0 to about 10 pphp, from 0 to about 8 pphp, from 0 to about 6 pphp, from 0 to about 4 pphp, from 0 to about 2 pphp, or from 0 to about 1 pphp. In another aspect, the urethane catalyst is present from 0 to about 0.8 pphp, from 0 to about 0.6 pphp, from 0 to about 0.4 pphp, or from 0 to about 0.2 pphp.

### Miscellaneous Additives

Depending upon the requirements during foam manufacturing or for the end-use application of the foam product, various additives can be employed in the PIR/PUR foam formulation to tailor specific properties. These preferably include, but are not limited to, cell stabilizers, flame retardants, chain extenders, epoxy resins, acrylic resins, fillers, pigments, or any combination thereof. It is understood that other mixtures or materials that are known in the art can be included in the foam formulations and are within the scope of the present invention.

Cell stabilizers include surfactants such as organopolysiloxanes. Silicon surfactants can be present in the foam formulation in amounts from about 0.5 to about 10 pphp, about 0.6 to about 9 pphp, about 0.7 to about 8 pphp, about 0.8 to about 7 pphp, about 0.9 to about 6 pphp, about 1 to about 5 pphp, or about 1.1 to about 4 pphp. Useful flame retardants include halogenated organophosphorous compounds and non-halogenated compounds. A non-limiting example of a halogenated flame retardant is trichloropropylphosphate (TCPP). For example, triethylphosphate ester (TEP) and dimethyl-methyl-phosphonate (DMMP) are non-halogenated flame retardants. Depending on the end-use foam application, flame retardants can be present in the foam formulation in amounts from 0 to about 50 pphp, from 0 to about 40 pphp, from 0 to about 30 pphp, or from 0 to about 20 pphp. In another aspect, the flame retardant is present from 0 to about 15 pphp, 0 to about 10 pphp, 0 to about 7 pphp, or 0 to about 5 pphp. Chain extenders such as ethylene glycol and butane diol can also be employed in the present invention. Ethylene glycol, for instance, can also be present in the formulation as a diluent or solvent for the carboxylate salt catalysts of the present invention.

### Polyisocyanurate/Polyurethane Foam Formulation and Process

One aspect of the present invention provides for a composition comprising the contact product of at least one active hydrogen-containing compound, at least one blowing agent, and a catalyst composition comprising at least one phase transfer trimer catalyst used in combination with at least one tertiary amine having at least one isocyanate reactive group. Another aspect provides a composition comprising the contact product of at least one polyisocyanate, at least one blowing agent, and a catalyst composition comprising at least one phase transfer trimer catalyst used in combination with at least one tertiary amine having at least one isocyanate reactive group. In both of these two compositions, the composition can further comprise at least one urethane catalyst having no isocyanate reactive group. Likewise, the compositions can further comprise at least one additive selected from at least one cell stabilizer, at least one flame retardant, at least one chain extender, at least one crosslinker, at least one emulsifying agent, at least one blowing agent compatibilizer, at least one cell opening agent, at least one epoxy resin, at least one acrylic resin, at least one filler, at least one pigment, or any combination thereof.

The present invention provides a method for preparing a polyisocyanurate/polyurethane (PIR/PUR) foam which comprises contacting at least one polyisocyanate with at least one active hydrogen-containing compound, in the presence of at least one blowing agent and an effective amount of a catalyst composition comprising at least one phase transfer trimer catalyst. In accordance with the method of the present invention, PIR/PUR foams can be produced having a density from about 8 Kg/m³ to about 250 Kg/m³ (about 1.25 lb/ft³ to about 15.5 lb/ft³), or from about 24 Kg/m³ to about 60 Kg/m³ (about 1.5 lb/ft³ to about 3.75 lb/ft³).

The instant invention can be used in a wide range of methods for making rigid closed-cell or alternatively open-cell foam. Examples of suitable methods comprise molding, spraying, among other rigid foam production methods. In one aspect the inventive method relates to a method for making a laminated foam.

In another aspect, the method of the present invention offers a substantially consistent foam height rise versus time—even at a high isocyanate index—that is highly desired for continuous foam manufacturing operations. The method for preparing PIR/PUR foams can also provide equivalent or faster surface cure when compared to other commercially available catalyst systems, such that the PIR/PUR foam has enhanced surface adherence, useful for the production are articles such as laminated foam panels.

Optionally, in yet another aspect, the method of the present invention can produce PIR/PUR foams with no or substantially no undesirable amine odor. Dependent upon the selection of the specific at least one phase transfer trimer catalyst, this method can provide thermal stability at the temperatures which PIR/PUR foams normally encounter during manufacturing, even those foams formulated with a high isocyanate index. In a further aspect, the method for preparing PIR/PUR foam has thermal stability up to about 150° C., or about 175° C., or about 200° C., or about 220° C., or about 240° C., or about 250° C. In a still further aspect, the method of the present invention produces PIR/PUR foam that is substantially free of volatile amines and/or amine odors.

The catalyst composition comprising at least one phase transfer trimer catalyst should be present in the foam formulation in a catalytically effective amount. In PIR/PUR foam formulations of the present invention, the catalyst composition is present in amounts from about 0.05 to about 10 parts by weight per hundred weight parts of the at least one active hydrogen-containing compound, excluding the weight contribution of the catalyst system diluent. In another aspect, the catalyst composition is present in amounts from about 0.4 to about 9 parts, or from about 0.8 to about 8 parts, by weight per hundred weight parts of the at least one active hydrogen-containing compound. If the at least one active hydrogen-containing compound is an at least one polyol, the catalyst composition is present in amounts from about 0.05 to about 10 parts by weight per hundred weight parts polyol (pphp). In another aspect, the catalyst composition is present in amounts from about 0.2 to about 9.5 pphp, about 0.4 to about 9 pphp, about 0.6 to about 8.5 pphp, or about 0.8 to about 8 pphp.

In accordance with one aspect of the method of the present invention, the components of the foam formulation are contacted substantially contemporaneously. For example, at least one polyisocyanate, at least one active hydrogen-containing compound, at least one blowing agent and an effective amount of a catalyst composition comprising at least one phase transfer trimer catalyst, are contacted together. Given the number of components involved in PIR/PUR formulations, there are many different orders of combining the components, and one of skill in the art would realize that varying the order of addition of the components falls within the scope of the present invention. As well, for each of the different orders of combining the aforementioned components of the foam formulation, the foam formulation of the present invention can further comprise at least one urethane catalyst. In addition, the method of producing PIR/PUR foams can further comprise the presence of at least one additive selected from at least one cell stabilizer, at least one emulsifier, at least one flame retardant, at least one chain extender, at least one crosslinker, at least one epoxy resin, at least one acrylic resin, at least one filler, at least one pigment, or any combination thereof. In one aspect of the present invention, all of the components, including optional components, are contacted substantially contemporaneously.

In another aspect of the present invention, a premix of ingredients other than the at least one polyisocyanate are contacted first, followed by the addition of the at least one polyisocyanate. For example, the at least one active hydrogen-containing compound, the at least one blowing agent, and the catalyst composition of the present invention are contacted initially to form a premix. The premix is then contacted with the at least one polyisocyanate to produce PIR/PUR foams in accordance with the method of the present invention. In a further aspect of the present invention, the same method can be employed, wherein the premix further comprises at least one urethane catalyst. Likewise, the premix can further comprise at least one additive selected from at least one cell stabilizer, at least one crosslinker, at least one flame retardant, at least one chain extender, at least one emulsifier, at least one epoxy resin, at least one acrylic resin, at least one filler, at least one pigment, or any combination thereof.

One aspect of the present invention provides a method for preparing a polyisocyanurate/polyurethane foam comprising (a) forming a premix comprising:
i) at least one polyol;
ii) about 1 to about 80 parts by weight per hundred weight parts of the polyol (pphp) blowing agent;
iii) about 0.5 to about 10 pphp silicon surfactant;
iv) zero to about 10 pphp water;
v) zero to about 50 pphp flame retardant;
vi) zero to about 10 pphp urethane catalyst; and
vii) about 0.05 to about 10 pphp of a catalyst composition comprising at least one phase transfer trimer catalyst; and
   (b) contacting the premix with at least one polyisocyanate at an isocyanate index from about 80 to about 800.
   As indicated previously, the blowing agent is not a chlorofluorocarbon (CFC).

The following is a list of preferred items of the invention:

Item 1. A composition comprising the contact product of:
(a) at least one active hydrogen-containing compound;
(b) a catalyst composition comprising at least one phase transfer trimer catalyst; and
(c) at least one blowing agent, with the proviso that the at least one blowing agent is not a chlorofluorocarbon.
   Item 2. The composition of item 1, wherein the at least one phase transfer trimer catalyst has the general formula A-CO₂⁻.⁺NR¹R²R³R⁴, where A is H and R¹, R², R³, and R⁴ are each independently methyl, ethyl, propyl, butyl or —CH₂—Ar and Ar is an aryl group; or where A is H, R¹ is —CH₂—CH₂OH or —CH₂—CH(OH)—CH₃, R² is —CH₂—Ar, and R³ and R⁴ are each independently methyl, ethyl, propyl or butyl and Ar is an aryl group; and
   wherein the blowing agent comprises formic acid.
   Item 3. The composition of item 1, wherein the at least one phase transfer trimer catalyst has the general formula A-CO₂⁻.⁺NR¹R²R³R⁴ where A is H or methyl, R¹ is —CH₂—CH₂OH or —CH₂—CH(OH)—CH₃, R² is —CH₂—Ar and Ar is an aryl group, and R³ and R⁴ are each independently methyl, ethyl, propyl or butyl; or where A is H or methyl, R¹ and R² and R³ are each independently methyl, ethyl, propyl or butyl, and R⁴ is —CH₂—Ar and Ar is an aryl group; or A is H or methyl, and R¹ and R² and R³ and R⁴ are each independently a C₁-C₄ alkyl group; and wherein the blowing agent comprises a C₅-hydrocarbon blowing agent.
   Item 4. The composition of item 1, wherein the at least one phase transfer trimer catalyst has the general formula A-CO₂⁻.⁺NR¹R²R³R⁴ where A is ethyl and R¹, R², R³, and R⁴ are each independently methyl, ethyl, propyl, butyl or —CH₂—Ar and Ar is an aryl group; and wherein the blowing agent comprises a C₅-hydrocarbon blowing agent.
   Item 5. The composition of item 1, wherein the at least one phase transfer trimer catalyst has the general formula A-CO₂⁻.⁺NR¹R²R³R⁴ where A is propyl and R¹, R², R³, and R⁴ are each independently methyl, ethyl, propyl, butyl or —CH₂—Ar and Ar is an aryl group; and wherein the blowing agent comprises a C₅-hydrocarbon blowing agent.
   Item 6. The composition of any of items 2-5, wherein Ar is —C₆H₅.
   Item 7. The composition of item 2, wherein the at least one phase transfer trimer catalyst comprises at least one member selected from the group consisting of tetramethylammonium formate, tetraethylammonium formate, tetrapropylammonium formate, tetrabutylammonium formate, benzyltrimethylammonium formate, benzyltrimethylammonium formate, benzyl-(2-hydroxypropyl)-dimethylammonium formate, and benzyl-(2-hydroxyethyl)-dimethylammonium formate.
   Item 8. The composition of item 3, wherein the at least one phase transfer trimer catalyst comprises at least one member selected from the group consisting of tetramethylammonium acetate, tetraethylammonium acetate, tetrapropylammonium acetate, tetrabutylammonium acetate, tetrabutylammonium formate, benzyltrimethylammonium formate, benzyltrimethylammonium acetate, benzyl-(2-hydroxypropyl)-dimethylammonium acetate and benzyl-(2-hydroxyethyl)-dimethylammonium acetate.
   Item 9. The composition of item 4, wherein the at least one phase transfer trimer catalyst comprises at least one member selected from the group consisting of tetramethylammonium propionate, tetraethylammonium propionate, tetrapropylammonium propionate, tetrabutylammonium propionate, and benzyltrimethylammonium propionate.
   Item 10. The composition of item 5, wherein the at least one phase transfer trimer catalyst comprises at least one member selected from the group consisting of tetramethylammonium butyrate, tetraethylammonium butyrate, tetrapropylammonium butyrate, tetrabutylammonium butyrate, and benzyltrimethylammonium butyrate.
   Item 11. The composition of any of items 1 to 10, further comprising a tertiary amine having or not an isocyanate reactive group.
   Item 12. The composition of any of items 1 to 11, further comprising at least one additive selected from at least one cell stabilizer, at least one flame retardant, at least one chain extender, at least one epoxy resin, at least one acrylic resin, at least one filler, at least one pigment, or any combination thereof.
   Item 13. A method for preparing a polyisocyanurate/polyurethane foam comprising contacting at least one polyisocyanate with at least one active hydrogen-containing compound in the presence of at least one blowing agent and a catalyst composition comprising at least one phase transfer trimer catalyst, wherein the at least one blowing agent is not a chlorofluorocarbon.
   Item 14. The method of item 13, wherein the at least one phase transfer trimer catalyst has the general formula A-CO₂⁻.⁺NR¹R²R³R⁴, where A is H and R¹, R², R³, and R⁴ are each independently methyl, ethyl, propyl, butyl or —CH₂—Ar and Ar is an aryl group; or where A is H, R¹ is —CH₂—CH₂OH or —CH₂—CH(OH)—CH₃, R² is —CH₂—Ar, and R³ and R⁴ are each independently methyl, ethyl, propyl or butyl and Ar is an aryl group; and wherein the blowing agent comprises formic acid.
   Item 15. The method of item 13, wherein the at least one phase transfer trimer catalyst has the general formula A-CO₂⁻.⁺NR¹R²R³R⁴ where A is H or methyl, R¹ is —CH₂—CH₂OH or —CH₂—CH(OH)—CH₃, R² is —CH₂—Ar and Ar is an aryl group, and R³ and R⁴ are each independently methyl, ethyl, propyl or butyl; or where A is H or methyl, R¹ and R² and R³ are each independently methyl, ethyl, propyl or butyl, and R⁴ is —CH₂—Ar and Ar is an aryl group; or A is H or methyl, and R¹ and R² and R³ and R⁴ are each independently a C₁-C₄ alkyl group; and wherein the blowing agent comprises a C₅-hydrocarbon blowing agent.
   Item 16. The method of item 13, wherein the at least one phase transfer trimer catalyst has the general formula A-CO₂⁻.⁺NR¹R²R³R⁴ where A is ethyl and R¹, R², R³, and R⁴ are each independently methyl, ethyl, propyl, butyl or —CH₂—Ar and Ar is an aryl group; and wherein the blowing agent comprises a C₅-hydrocarbon blowing agent.
   Item 17. The method of claim 13, wherein the at least one phase transfer trimer catalyst has the general formula A-CO₂⁻.⁺NR¹R²R³R⁴ where A is propyl and R¹, R², R³, and R⁴ are each independently methyl, ethyl, propyl, butyl or —CH₂—Ar and Ar is an aryl group; and wherein the blowing agent comprises a C₅-hydrocarbon blowing agent.
   Item 18. The method of any of items 13-17, wherein Ar is —C₆H₅.
   Item 19. The method of item 14, wherein the at least one phase transfer trimer catalyst comprises at least one member selected from the group consisting of tetramethylammonium formate, tetraethylammonium formate, tetrapropylammonium formate, tetrabutylammonium formate, benzyltrimethylammonium formate, benzyltrimethylammonium formate, benzyl-(2-hydroxypropyl)-dimethylammonium formate, and benzyl-(2-hydroxyethyl)-dimethylammonium formate.
   Item 20. The method of item 15, wherein the at least one phase transfer trimer catalyst comprises at least one member selected from the group consisting of tetramethylammonium acetate, tetraethylammonium acetate, tetrapropylammonium acetate, tetrabutylammonium acetate, tetrabutylammonium formate, benzyltrimethylammonium formate, benzyltrimethylammonium acetate, benzyl-(2-hydroxypropyl)-dimethylammonium acetate and benzyl-(2-hydroxyethyl)-dimethylammonium acetate.
   Item 21. The method of item 16, wherein the at least one phase transfer trimer catalyst comprises at least one member selected from the group consisting of tetramethylammonium propionate, tetraethylammonium propionate, tetrapropylammonium propionate, tetrabutylammonium propionate, and benzyltrimethylammonium propionate.
   Item 22. The method of item 17, wherein the at least one phase transfer trimer catalyst comprises at least one member selected from the group consisting of tetramethylammonium butyrate, tetraethylammonium butyrate, tetrapropylammonium butyrate, tetrabutylammonium butyrate, and benzyltrimethylammonium butyrate.
   Item 23. The method of any of items 13-22, wherein the catalyst composition is present in combination with a tertiary amine having or not an isocyanate reactive group.
   Item 24. The method of any of items 13-23 comprising
   (a) forming a premix comprising:
i) at least one polyol;
ii) about 1 to about 80 parts by weight per hundred weight parts of the polyol (pphp) blowing agent;
iii) about 0.5 to about 10 pphp silicon surfactant;
iv) zero to about 10 pphp water;
v) zero to about 50 pphp flame retardant;
vi) zero to about 10 pphp urethane catalyst; and
vii) about 0.05 to about 10 pphp of a catalyst composition comprising at least one phase transfer trimer catalyst; and
   (b) contacting the premix with at least one polyisocyanate at an isocyanate index from about 80 to about 800.

### EXAMPLES

These examples are provided to demonstrate certain aspects of the invention and shall not limit the scope of the claims appended hereto.

The foams were produced by adding catalysts into a premix of a polyol (polyester polyol with 230-250 hydroxyl number and equivalent weight=234 supplied by Stepanpol), flame retardant (TCPP; tris(1-chloro-2-propyl) phosphate), surfactant (for pentane blown Dabco®DC5598 and for formic acid/pentane blown DABCO®SI3201 both of which are silicone surfactants supplied by Evonik Corporation), blowing agent (typically n-pentane or a mixture of n-pentane and 85% formic acid in water) and alternatively water mixture in a 1759 mL beaker. This composition was mixed for about 5 seconds (s) at about 5,000 RPM (or 3000 rpm where specified) using an overhead stirrer fitted with a 6.2-cm diameter stirring paddle. Isocyanate was then added to achieve the desired Isocyanate Index which was typically in the 270-300 range. Then the premix was mixed well for about 5 seconds (s) at about 5,000 RPM using the same stirrer. The 1759 mL beaker was placed under a FORMAT sonar device. This allows the foam to expand inside the 1759 ml beaker and move upwards since the walls of the beaker restricts lateral expansion of the foaming mass. At end of the foaming process, the foam height was about 10 cm higher and above the 1759 ml beaker edge. String gel time (defined as the time in seconds at which the polymerizing mass is able to form polymer strings when touched with a wooden tongue suppressor) and tack free time (TFT; defined as the time in seconds for the surface to attain a sufficient robust state or cure that no damage or stickiness occurs on the surface when touched with a wooden tongue suppressor) were measured using a chronometer and determined manually using a tongue suppressor. Start time was defined as the time in seconds when the foaming mass begins expansion.

TABLE 1
Lamination Control Formulations
Control Formulation of Foams

| Formulation Type | Control A | Control B | NOTES |
|---|---|---|---|
| COMPONENTS | Weight (g) | Weight (g) | NOTES |
| Stepanpol ® PS2352 | 100 | 100 | Polyester polyol with 230-250 hydroxyl number and |
| | | | equivalent weight = 234 supplied by Stepanpol |
| Dabco ® DC5598 | 1.97 | — | Silicone surfactant supplied by Evonik Corporation |
| Dabco ® SI3201 | | 2.0 | Silicone surfactant supplied by Evonik Corporation |
| TCPP | 13.55 | | tris(1-chloro-2-propyl) phosphate flame retardant |
| H₂O | 0.51 | | Water |
| Pentane | 19.68 | 11 | n-pentane blowing agent |
| Formic Acid | | 1.70 | Formic acid 85 wt.% in water |
| Polycat ®-5 | 0.17 | 0.50 | Pentamethyldiethylenetriamine supplied by Evonik |
| | | | Corporation |
| DABCO ® K15 | 1.85 | | Potassium 2-ethylhexanoate solution in diethylene |
| | | | glycol |
| DABCO ® TMR25 | | 3.0 | Potassium formate dissolved in ethylene glycol |
| | | | supplied commercially by Evonik Corporation |
| Isocyanate | 191.4 | 243.29 | |
| Isocyanate Index | 270 | 450 | Commercially available MDI with % NCO = 31.2 |

TABLE II
Lamination Experimental Formulations
Control Formulation of Foams

| Formulation Type | Formulation C | FormulationI D | NOTES |
|---|---|---|---|
| COMPONENTS | PPHP | PPHP | NOTES |
| Stepanpol ® PS2352 | 100 | 100 | Polyester polyol with 230-250 hydroxyl number and |
| | | | equivalent weight = 234 supplied by Stepanpol |
| Dabco ® DC5598 | 1.97 | — | Silicone surfactant supplied by Evonik Corporation |
| Dabco ® SI3201 | | 2.0 | Silicone surfactant supplied by Evonik Corporation |
| TCPP | 13.55 | | tris(1-chloro-2-propyl) phosphate flame retardant |
| H₂O | 0.51 | | Water |
| Pentane | 19.68 | 11 | n-pentane blowing agent |
| Formic Acid | | 1.70 | Formic acid 85 wt.% in water |
| Polycat ®-5 | 0.17 | 0.50 | Pentamethyldiethylenetriamine supplied by Evonik |
| | | | Corporation |
| Trimer Catalyst | Varied | Varied | |
| Isocyanate Index | 270 | 300 | |
| Isocyanate (PPHP) | 191.4 | 450 | Commercially available MDI with % NCO = 31.2 |

Various types and quantities of catalysts were used to produce PIR/PUR foams of the present invention. Table I and Table II lists the components of a typical lamination PIR foam formulation and their respective amounts that are used in these examples for pentane blown foam and for pentane/formic acid blown foams.

### Example 1

### Comparison Between Various Catalysts Having Phase Transfer Cations and Standard PIR Catalysts Using Formulation B and D Blown with Pentane-Formic Acid Mixture

Table III shows the foam rise kinetic data as well as other reactive properties of polyurethane foaming mass including string gel time and tack free time as defined previously for PIR foam that uses formic acid-pentane mixtures as blowing agents. All the catalysts are formate salts with the exception of TMAA (tetramethylammonium acetate) having different cations that can serve, depending on the case, as a phase transfer trimer agent to improve the contact between the catalytic anionic species with the isocyanate phase. By setting approximately the same string gel time (SGT) it is possible to see an improvement in the tack free time when switching from potassium formate to tetramethylammonium formate. Switching from potassium formate to tetramethylammonium formate changes the tack free time from about 85 seconds to about 75 seconds or more than 10%. Increasing the hydrophobicity of the cation and switching from potassium formate to tetrabutylammonium formate does not make any effective improvement (reduction) on the tack free time. This is surprising since the tetrabutylammonium cation is known to facilitate ionic transport from a polar phase (formic acid/water) to an organic phase (isocyanate). A much better result was obtained when using benzyltrimethylammonium formate also showing about 10% improvement on tack free time relative to potassium formate. However, the best result was obtained with BDMHPF (benzyldimethyl-(2-hydroxypropyl)ammonium formate) for which case the tack free time was reduced to only 67 seconds and showing an improvement of about 20% relative to potassium formate. This improvement is shown to occur without much change in the initial stages of the polymerization reaction (cream time) which is important to maintain flow of the material being poured. Tetramethylammonium acetate is the worst performing catalyst. Thus, BDMHPF (benzyldimethyl-(2-hydroxypropyl)ammonium formate) is the most preferred catalyst while TMAF (tetramethylammomium formate) and BTMAF (benzyltrimethylammonium formate) are preferred catalysts and TBAF (tetrabutylammonium formate) is the least preferred and TMAA (tetramethylammonium acetate) is a non-preferred catalyst when formic-pentane mixture is used as blowing agent.

TABLE III
Foam Rise Data for Catalysts with Phase Transfer Trimer Cations:
Formulation B and D

| | | | | | | | | | | Final | Height | Rise | | | |
|---|---|---|---|---|---|---|---|---|---|---|---|---|---|---|---|
| | | | Cat | | | | | | | Foam | at | at | Free | | |
| | Trimer | Cat | Active | Cat | CT | TOC | SGT | TFT | Rise | Ht | SGT | SGT | Rise | Cat | Cat |
| Foam | Catalyst | pphp | Pphp | mmoles | (sec) | (sec) | (sec) | (sec) | Time | (mm) | (mm) | (%) | Density | MW | Conc⁵ |
| 1 | TMR25 | 3.0 | 1.0 | 12.5 | 8 | 50 | 60 | 85 | 88 | 320 | 258 | 81 | 40 | 84.1 | 0.35 |
| 2 | TMAF¹ | 3.1 | 1.3 | 11.0 | 8 | 50 | 57 | 75 | 82 | 316 | 247 | 78 | 40 | 119.2 | 0.42 |
| 3 | TBAF² | 5.7 | 2.7 | 9.6 | 8 | 52 | 59 | 84 | 91 | 309 | 230 | 74 | 42 | 287.5 | 0.49 |
| 4 | BTMAF³ | 4.7 | 2.2 | 11.4 | 8 | 52 | 58 | 77 | 85 | 313 | 230 | 73 | 43 | 195.3 | 0.47 |
| 5 | BDMHPF⁴ | 6.3 | 3.1 | 13.2 | 8 | 53 | 56 | 67 | 75 | 298 | 223 | 75 | 44 | 239.3 | 0.50 |
| 6 | TMAA⁵ | 2.2 | 1.4 | 10.7 | 8 | 49 | 58 | 98 | 88 | 313 | 242 | 77 | 41 | 133.2 | 0.66 |

DABCO ® TMR25 is a 35% solution of potassium formate in ethylene glycol;
¹TMAF = Tetramethylammonium formate in ethylene glycol;
²TBAF = tetrabutylammonium formate in ethylene glycol;
³BTMAF = Benzyltrimethylammonium formate in ethylene glycol;
⁴BDMHPF = Benzyldimethyl-(2-hydroxypropyl)ammonium formate in ethylene glycol;
⁵TMAA = Tetramethylammonium acetate in ethylene glycol

TABLE IV
Foam Friability Data for Catalysts with Phase transfer trimer Cations:
Formulations B and D Measured Using ASTM C421 Method

| | | Initial | First Cycle 600 | Second Cycle 600 | % Mass Loss After | % Mass Loss After |
|---|---|---|---|---|---|---|
| | Trimer | Weight | revolutions 10′ | revolutions 10′ | First Cycle | Second Cycle |
| Foam | Catalyst | Grams | grams | Mmoles | (sec) | (sec) |
| 7 | TMR-25 | 6.62 | 5.82 | 4.83 | 12.1 | 27.0 |
| 8 | TMAF | 6.88 | 6.12 | 5.06 | 11.0 | 26.4 |
| 9 | BTMAF | 6.97 | 6.22 | 4.88 | 10.8 | 30.0 |
| 10 | BDMHPF | 7.40 | 6.49 | 5.41 | 12.3 | 26.9 |
| 11 | TMAA | 6.98 | 6.13 | 4.82 | 12.2 | 30.9 |

Table IV displays the foam friability data for various catalysts and the results indicate not significant difference when switching catalysts.

TABLE V
Curing Profile Data for Catalysts with Phase transfer trimer Cations:
Formulations B and D

| Time (minutes) | TMR-25 | TMAF | BTMAF | BDMHPF | TBAF | TMAA |
|---|---|---|---|---|---|---|
| 3:45 | 23.6 | 22.1 | 24.1 | 18.3 | 20.6 | 22.4 |
| 5:45 | 31.5 | 30.8 | 32.3 | 24.4 | 28 | 29.8 |
| 7:45 | 29.2 | 28.2 | 28.3 | 27.5 | 28.7 | 29.2 |
| 9:45 | 34.8 | 34.7 | 31.8 | 32.8 | 31.8 | 32.4 |
| 11:45 | 30.2 | 30.8 | 29.1 | 33.2 | 29.9 | 31.8 |

Table V displays the curing foam profile data for various catalysts and the results indicate slightly lower initial cure for the most preferred catalyst BDMHPF but better back end cure when compared to potassium formate. TMAF on the other hand showed similar cure profile to the standard based on potassium formate.

### Example 2

### Comparison Between Various Catalysts Having Phase Transfer Trimer Cations and Standard PIR Catalysts Using Formulation A and C Blown with Pentane

Table VI shows foam rise kinetic data as well as other reactive properties of polyurethane foaming mass including string gel time and tack free time as defined previously for PIR foam that uses pentane as blowing agent. The catalysts tested in Table VI show the data for the standard commercial product used in PIR lamination DABCO®K15 and a group of catalysts of this invention with all measurements carried out at a string gel time of approximately 59 seconds. The data shows substantial improvement in the tack free time when switching from DABCO®K15 to BDMHPAA or BTMAF. Switching from DABCO®K15 to BDMHPAA or BTMAF shortens the tack free time from about 156 seconds to about 67-68 seconds for BDMHPAA and to 60 seconds for BTMAF or more than 50% improvement in each case. In addition to the benefit of improved tack free time BDMHPAA provides an additional front end delay of about 12-13 seconds relative to the DABCO®K15 standard (cream time for BDMHPAA=25 seconds while cream time of DABCO®K15=12 seconds) which improves the flow of the polymerizing mixture and helps minimizing knit lines in the manufacturing of continuous lamination panels as well as improving mold filling efficiency in discontinuous production lines reducing scrap and optimizing material usage. Surprisingly, the delay in the cream time takes place at the same string gel time and more surprisingly this inventive catalyst is able to further provide a much shorter tack free time. This dual effect of front delay (longer cream time) and short tack free time is not seen in BTMAF though. BDMHPF also shows substantial lengthening of the cream time being about 8 seconds longer than the standard DABCO®K15. However, BDMHPF has a much lower foam height and the cell structure and quality of the foam is very poor.

TABLE VI
Foam Rise Data for Catalysts with Phase transfer trimer Cations:
Formulation A and C

| | | | Cat | | | | | | Final | Rise | Free | | |
|---|---|---|---|---|---|---|---|---|---|---|---|---|---|
| | Trimer | Cat | Active | Cat | CT | TOC | SGT | TFT | Height | Time | Rise | Cat | Cat |
| Foam | Catalyst | pphp | pphp | mmoles | (sec) | (sec) | (sec) | (sec) | (mm) | (s) | Density | MW | Conc |
| 12 | DABCO ® K15¹ | 1.85 | 1.38 | 7.58 | 12 | 40 | 59 | 156 | 319 | 84 | 38 | 182.0 | 0.75 |
| 13 | BDMHPAA² | 6.00 | 3.00 | 11.8 | 25 | 53 | 59 | 68 | 310 | 82 | 40 | 253.3 | 0.50 |
| 14 | BDMHPAA² | 6.00 | 3.00 | 11.8 | 26 | 54 | 58 | 67 | 314 | 80 | 40 | 253.3 | 0.50 |
| 15 | BDMHPF | 10.75 | 5.37 | 22.5 | 20 | 54 | 58 | 64 | 296 | 78 | 42 | 239.3 | 0.50 |
| 16 | BTMAA | 3.85 | 1.65 | 7.89 | 14 | 47 | 58 | 76 | 338 | 84 | 35 | 209.3 | 0.43 |
| 17 | BTMAF | 5.75 | 2.70 | 13.8 | 14 | 46 | 56 | 60 | 349 | 77 | 34 | 195.3 | 0.47 |
| 18 | TMAA | 2.36 | 1.55 | 11.6 | 15 | 50 | 62 | 122 | 309 | 91 | 40 | 133.2 | 0.66 |

¹Dabco ® K15 is a 70% solution of potassium 2-ethylhexanoate in diethylene glycol supplied by Evonik Corporation;
²BDMHPAA = Benzyldimethyl-(2-hydroxypropyI)-ammonium-acetate solution in ethylene glycol;
BDMHPF = Benzyldimethyl-(2-hydroxypropyl)-ammonium formate;
BTMAA = benzyltrimethylammonium acetate solution in ethylene glycol;
BTMAF = benzyltrimethylammonium formate solution in ethylene glycol;
TMAA = tetramethylammonium acetate solution in ethylene glycol;
Mixing for 5 seconds at 3000 rpm

Similarly, as shown in Table VII (where mixing was done for 3 seconds at 3000 rpm) a decrease in the tack free time is observed when switching from DABCO®K15 to other trimer catalyst salts having cation that can act as phase transfer trimer catalysts. Thus, switching from DABCO®K15 to BTMAA shortens the tack free time from about 158 seconds to about 105 seconds or more than 30% improvement. Similar effect is observed for the other catalysts and the shortest tack free time corresponds to BTMAF with 80 seconds or an approximate 50% reduction on tack free time. The catalysts in Table VII also showed a front-end delay as measured by the cream time although the values are much more modest than those measured for BDMHPAA (benzyldimethyl-(2-hydroxypropyl) ammonium acetate) shown in Table VI. Surprisingly, these benefits do not show to substantially affect other properties such as foam density. Thus, BDMHPAA (benzyldimethyl-(2-hydroxypropyl) ammonium acetate) is the most preferred catalyst while BTMAF (benzyltrimethylammonium formate), BTMAA (benzyltrimethylammonium acetate), tetrabutylammonium acetate, tetramethylammonium acetate and tetrabutylammonium formate are preferred catalysts, while BDMHPF (benzyldimethyl-(2-hydroxypropyl)ammonium formate) is non preferred when pentane is the sole blowing agent.

TABLE VII
Foam Rise Data for Catalysts with Phase transfer trimer Cations:
Formulation A and C

| | | | | | | | | | Height | Final Ht - | Rise | Free | | |
|---|---|---|---|---|---|---|---|---|---|---|---|---|---|---|
| | Trimer | Cat | Cat Active | Cat | CT | TOC | SGT | TFT | at SGT | Ht at | Time | Rise | Cat | Cat |
| Foam | Catalyst | pphp | pphp | mmoles | (sec) | (sec) | (sec) | (sec) | (mm) | SGT | (s) | Density | MW | Conc |
| 19 | DABCO ® K15¹ | 1.85 | 1.39 | 7.58 | 12 | 43 | 69 | 158 | 271 | 49 | 99 | 38 | 182.0 | 0.75 |
| 20 | BTMAA² | 3.85 | 1.65 | 7.88 | 15 | 57 | 69 | 105 | 262 | 71 | 105 | 35 | 209.3 | 0.43 |
| 21 | TBAA³ | 4.50 | 2.25 | 7.46 | 16 | 53 | 69 | 122 | 270 | 56 | 103 | 37 | 301.5 | 0.50 |
| 22 | TBAF⁴ | 4.95 | 2.37 | 8.24 | 15 | 61 | 69 | 110 | 274 | 57 | 108 | 36 | 287.5 | 0.48 |
| 23 | BTMAF⁵ | 5.75 | 2.70 | 13.8 | 14 | 61 | 69 | 80 | 262 | 72 | 103 | 36 | 195.3 | 0.47 |

¹Dabco ® K15 is a 70% solution of potassium 2-ethylhexanoate in diethylene glycol supplied by Evonik Corporation;
²BTMAA = Benzyltrimethylammonium acetate;
³TBAA = Tetrabutylammonium acetate;
⁴TBAF = Tetrabutylammonium formate;
⁵BTMAF = Benzyltrimethylammonium formate;
Mixing for 3 seconds at 3000 rpm

Table VIII displays the foam friability data for various catalysts and the results indicate a very significant improvement for the most preferred catalysts BDMHPAA. Other catalysts showed more friability than the standard DABCO®K15.

TABLE VIII
Foam Friability Data for Catalysts with Phase transfer trimer Cations:
Formulations A and C Measured Using ASTM C421 Method

| | | | First Cycle 600 | Second Cycle 600 | % Mass Loss After | % Mass Loss After |
|---|---|---|---|---|---|---|
| | | Initial Weight | revolutions 10′ | revolutions 10′ | First Cycle | Second Cycle |
| Foam | Trimer Catalyst | Grams | grams | Mmoles | (sec) | (sec) |
| 24 | DABCO ® K15 | 5.38 | 4.40 | 3.44 | 18.2 | 36.1 |
| 25 | BDMHPAA | 5.61 | 4.88 | 3.88 | 13.0 | 30.8 |
| 26 | BTMAA | 4.94 | 4.10 | 3.09 | 17.0 | 37.4 |
| 27 | TBAA | 4.23 | 3.20 | 2.14 | 24.3 | 49.4 |
| 28 | BTMAF | 4.70 | 3.60 | 2.45 | 23.4 | 47.8 |

Table IX shows the curing profile of various catalysts showing some initial slower cure which levels off after about 12 minutes showing comparable compression strengths for all cases.

TABLE IX
Curing Profile Data for Catalysts with Phase transfer trimer Cations:
Formulations A and C

| Time (minutes) | DABCO ® K15 | BDMHPAAc | BTMAAc | TBAAc | TBAF | BTMAF |
|---|---|---|---|---|---|---|
| 3:45 | 22.3 | 13.6 | 17.2 | 17.3 | 16.5 | 14.9 |
| 5:45 | 25.6 | 19.4 | 24.6 | 24.2 | 22.0 | 19.0 |
| 7:45 | 25.2 | 18.6 | 24.3 | 24.1 | 22.6 | 20.8 |
| 9:45 | 27.6 | 23.1 | 26.8 | 29.7 | 24.4 | 21.0 |
| 11:45 | 25.1 | 26.4 | 26.7 | 27.1 | 24.6 | 23.7 |

### Example 3

### Comparison Between Various Catalyst Salts Having Phase Transfer Trimer Cations and Pivalate Anions Using PIR Formulation A and C Blown with Pentane

Table X, shows the tack free time for various catalysts based on pivalic acid salts of potassium, tetramethylammonium and benzyltrimethylammonium cations. No substantial increase on the cream time is observed for this group of catalysts relative to the standard DABCO®K15. Nevertheless, a substantial shortening in the tack free time is seen for benzyltrimethylammonium pivalate while foam density remained essentially unchanged.

TABLE X
Foam Rise Data for Catalysts with Phase transfer trimer Cations:
Formulation A and C

| | | | | | | | | | Height | Final Ht - | Rise | Free | | |
|---|---|---|---|---|---|---|---|---|---|---|---|---|---|---|
| | Trimer | Cat | Cat Active | Cat | CT | TOC | SGT | TFT | at SGT | Ht at | Time | Rise | Cat | Cat |
| Foam | Catalyst | pphp | pphp | mmoles | (sec) | (sec) | (sec) | (sec) | (mm) | SGT | (s) | Density | MW | Conc |
| 29 | DABCO ® K15¹ | 1.85 | 1.39 | 7.58 | 12 | 43 | 69 | 158 | 275 | 45 | 99 | 38 | 182.0 | 0.75 |
| 30 | KP² | 1.71 | 0.85 | 6.06 | 13 | 48 | 67 | 135 | 281 | 46 | 95 | 37 | 140.2 | 0.50 |
| 31 | TMAP³ | 2.31 | 1.15 | 6.56 | 13 | 59 | 69 | 114 | 251 | 70 | 104 | 37 | 175.3 | 0.50 |
| 32 | BTMAP¹ | 4.12 | 1.77 | 7.04 | 12 | 57 | 69 | 100 | 267 | 61 | 103 | 37 | 251.3 | 0.43 |

¹Dabco ® K15 is a 70% solution of potassium 2-ethylhexanoate in diethylene glycol supplied by Evonik Corporation;
²KP is a 50% solution of potassium pivalate in ethylene glycol;
³TMAP is a 50% solution of tetramethylammonium pivalate in 50% ethylene glycol;
⁴BTMAP = Benzyltrimethylammonium pivalate

Table XI displays the foam friability data for various pivalate salt catalysts and the results indicate some deterioration for all pivalate catalysts. BTMAP did show improvement relative to TMAP but its performance was a bit worse than DABCO®K15.

TABLE XI
Foam Friability Data for Catalysts with Phase transfer trimer Cations:
Formulations A and C Measured Using ASTM C421 Method

| | | | First Cycle 600 | Second Cycle 600 | % Mass Loss After | % Mass Loss After |
|---|---|---|---|---|---|---|
| | Trimer | Initial Weight | revolutions 10′ | revolutions 10′ | First Cycle | Second Cycle |
| Foam | Catalyst | grams | grams | mmoles | (sec) | (sec) |
| 33 | DABCO ® K15 | 5.38 | 4.40 | 3.44 | 18.2 | 36.1 |
| 34 | KP | 4.23 | 3.50 | 2.54 | 17.3 | 39.9 |
| 35 | TMAP | 4.19 | 2.96 | 1.94 | 29.4 | 53.7 |
| 36 | BTMAP | 4.09 | 3.22 | 2.30 | 21.3 | 43.8 |

Table XII shows the curing profile of various catalysts showing some initial slower cure which levels off after about 12 minutes showing comparable compressive strengths for all cases.

TABLE XII
Curing Profile Data for Catalysts with Phase transfer trimer Cations:
Formulations A and C

| Time (minutes) | DABCO ® K15 | KP | TMAP | BTMAP |
|---|---|---|---|---|
| 3:45 | 22.3 | 21.1 | 18.6 | 16.8 |
| 5:45 | 25.6 | 25.3 | 23.3 | 24.5 |
| 7:45 | 25.2 | 26.4 | 23.4 | 24.3 |
| 9:45 | 27.6 | 29.3 | 26.7 | 27.5 |
| 11:45 | 25.1 | 26.6 | 27.0 | 26.5 |

### Example 4

### Performance of Standard Catalyst Using PIR Formulation with Freon Gas

Table XIII shows formulations E, F and G in which 17 parts of pentane have been replaced by Freon blowing agent R11 at 17 parts, 25 parts and 30 parts. The objective of the new formulations is to produce with the same amount of raw materials a foam with the same foam height and volume or at least as close as possible as to foam made with 17 parts of pentane. In this regard, it is expected that an equivalent foam volume will be produced with the same amount of raw materials.

TABLE XIII
Lamination Formulations with Freon Blowing Agent
Control Formulation of Foams

| Formulation Type | Formulation E | Formulation F | FormulationI G | NOTES |
|---|---|---|---|---|
| COMPONENTS | PPHP | PPHP | PPHP | NOTES |
| Stepanpol ® PS2352 | 100 | 100 | 100 | Polyester polyol with 230-250 |
| | | | | hydroxyl number and |
| | | | | equivalent weight = 234 |
| | | | | supplied by Stepanpol |
| Dabco ® DC5598 | 1.97 | 1.97 | 1.97 | Silicone surfactant supplied by |
| | | | | Evonik Corporation |
| TCPP | 13.55 | 13.55 | 13.55 | tris(1-chloro-2-propyl) |
| | | | | phosphate flame retardant |
| H2O | 0.51 | 0.51 | 0.51 | Water |
| Freon ® R11 | 19.68 | 28.94 | 34.72 | n-pentane blowing agent |
| Polycat ®-5 | 0.17 | 0.17 | 0.17 | Pentamethyldiethylenetriamine |
| | | | | supplied by Evonik Corporation |
| DABCO ® K15 | 1.85 | 1.85 | 1.85 | |
| Isocyanate | 166 | 166 | 166 | |
| Isocyanate Index | 270 | 270 | 270 | Commercially available MDI |
| | | | | with % NCO = 31.2 |

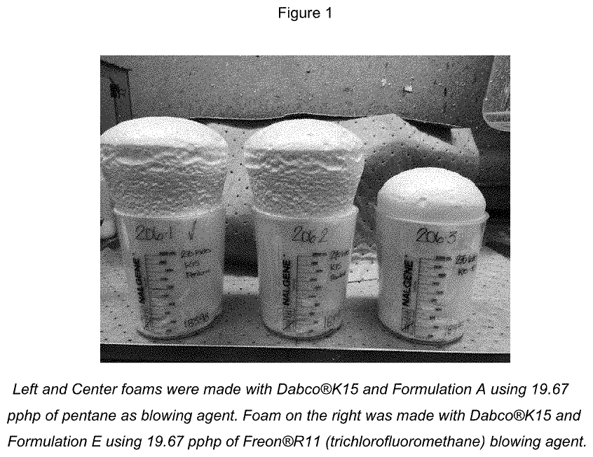

When Formulation E is used to make foam it was found that the foam height was much lower than the foam produced with pentane and consequently its volume was much smaller as shown in FIG. 1.

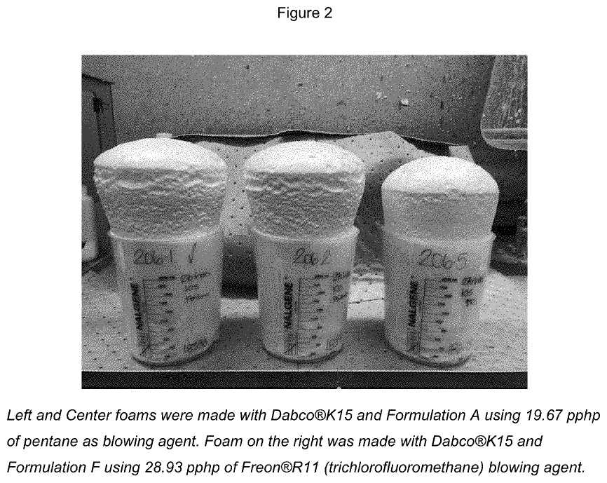

Increasing the amount of Freon®R11 to 28.93 pphp improved the foam height and foam volume but it still did not reach the foam height corresponding to the pentane blown foam as shown in FIG. 2.

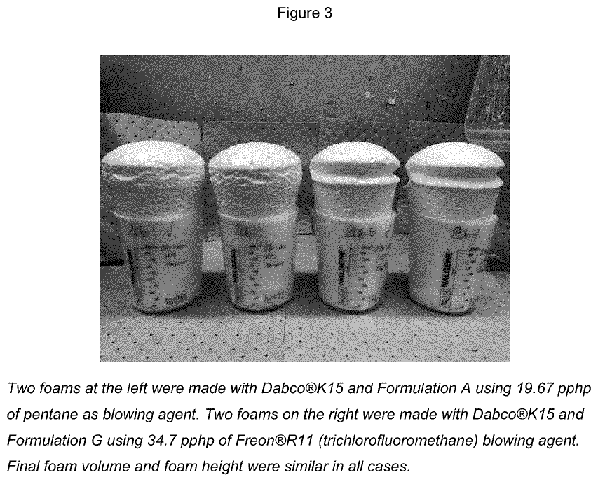

Finally when the amount of Freon®R11 was increased to 34.7 pphp the foam height improved and foam volume reached a foam height similar to the pentane blown foam as shown in FIG. 3.

The foam kinetic data as well as other parameters can be summarized in Table XIV using in all cases DABCO®K15 as trimer catalyst. Thus, a much larger use level of Freon®R11 is needed to obtain a similar foam height when compared to a pentane blown foam.

TABLE XIV
Standard Formulations with Freon Blowing Agent

| Formulation | Control A | Control A | G | G |
|---|---|---|---|---|
| Blowing Agent | Pentane | Pentane | R-11 | R-11 |
| Trimer pphp | 1.85 | 1.85 | 1.85 | 1.85 |
| CT | 13 | 11 | 10 | 12 |
| TOC | 34 | 33 | 31 | 30 |
| SGT | 50 | 49 | 40 | 39 |
| Rise at SGT (%) | 84.4% | 86.0% | 80.7% | 83.2% |
| Height at SGT (mm) | 269.0 | 272.5 | 260.1 | 269.5 |
| Final Ht—SGT Ht (mm) | 49.9 | 44.4 | 62.3 | 54.4 |
| TFT | 108 | 109 | 87 | 87 |
| Rise Time | 71.6 | 67.1 | 67.3 | 66.1 |
| Final Foam height | 318.9 | 316.9 | 322.4 | 323.9 |
| Foam wt | 191.39 | 190.87 | 384.89 | 190.83 |
| Foam Density kg/m³ | 37.8 | 38.3 | 39.6 | 39.7 |
| Mixing Time (sec) | 5 | 5 | 5 | 5 |

### Example 5

### Comparison of Performance of Various Experimental Catalysts Having Phase Transfer Trimer Cations Using PIR Formulation Blown with Freon Gas and Pentane at the Same String Gel Time

Table XV shows the performance of various carboxylate salts with different phase transfer trimer catalysts and their performance using the blowing agent used in the prior art Freon®R11 and their comparison with the same catalysts in formulations which are n-pentane blown at the same string gel time. Table XV also shows the performance of DABCO®K15 a standard catalyst widely used by the industry when using Freon®R11 and its comparison with pentane blowing agent.

TABLE XV
Foam Rise Data for Catalysts with Phase Transfer Trimer Cations:
Formulation A (Pentane) and G (Freon ® R11) at the Same String gel Time

| | | | Cat | | | | | | | Rise | Final | FR | | |
|---|---|---|---|---|---|---|---|---|---|---|---|---|---|---|
| | | Cat | Active | Cat | Blowing | CT | TOC | SGT | TFT | Time | Rise | Density | Cat | Cat |
| Foam | Cat | PPHP | PPHP | mmoles | Agent | (sec) | (sec) | (sec) | (sec) | (s) | Ht | kg/m³ | MW | Conc |
| 37 | K15 | 1.85 | 1.388 | 9.895 | Pentane | 12 | 40 | 59 | 157 | 85 | 315 | 39 | 182.00 | 0.7500 |
| 38 | K15 | 1.50 | 1.125 | 8.023 | R11 | 14 | 48 | 59 | 164 | 102 | 308 | 42 | 182.00 | 0.7500 |
| 39 | TMAA | 2.36 | 1.550 | 11.640 | Pentane | 15 | 50 | 63 | 122 | 91 | 309 | 40 | 133.19 | 0.6569 |
| 40 | TMAA | 1.40 | 0.920 | 6.905 | R11 | 18 | 54 | 59 | 91 | 94 | 308 | 42 | 133.19 | 0.6569 |
| 41 | BTMAA | 4.46 | 1.919 | 9.170 | Pentane | 14 | 55 | 63 | 92 | 92 | 327 | 37 | 209.29 | 0.4303 |
| 42 | BTMAA | 3.14 | 1.351 | 6.456 | R11 | 23 | 58 | 62 | 114 | 104 | 312 | 42 | 209.29 | 0.4303 |
| 43 | BDMHPAA | 6.94 | 3.470 | 13.697 | Pentane | 15 | 55 | 60 | 71 | 80 | 303 | 40 | 253.34 | 0.5000 |
| 44 | BDMHPAA | 4.00 | 2.000 | 7.895 | R11 | 21 | 53.6 | 59 | 86 | 90 | 311.4 | 41 | 253.34 | 0.5000 |
| 45 | TBAF | 5.73 | 2.786 | 9.691 | Pentane | 14 | 52 | 62 | 98 | 95 | 338 | 35 | 287.48 | 0.4862 |
| 46 | TBAF | 4.63 | 2.251 | 7.830 | R11 | 20 | 53 | 60 | 116 | 103 | 333 | 38 | 287.48 | 0.4862 |

¹Dabco ® K15 is a 70% solution of potassium 2-ethylhexanoate in diethylene glycol supplied by Evonik Corporation;
²BDMHPAA = Benzyldimethyl-(2-hydroxypropyl)-ammonium-acetate;
Mixing for 5 seconds at 3000 rpm

Table XV shows a comparison between foam samples made with standard alkali metal carboxylate salt such as potassium 2-ethylhexanoate (DABCO®K15) at the same foam string gel time using pentane and Freon®R11. For the standard, there is not a substantial difference between the tack free time when Freon®R11 is replaced with pentane blowing agent (157 seconds for pentane and 164 seconds for R11). Replacing the catalyst potassium 2-ethylhexanoate for tetramethylammonium acetate (TMAA) makes the tack free time shorter than the standard potassium salt. However, the TFT is substantially worse for the pentane blown foam (122 seconds) than for the R11 blown foam (91 seconds). However, the situation reverses when the tetramethyl cation is replaced for more efficient phase transfer trimer cations as shown in foam samples 41 to 46. Thus, substantial improvements in the TFT are observed when replacing Freon®R11 for pentane for formulations using benzyltrimethylammonium acetate (BTMAA), BDMHPAA (benzyldimethylhydroxypropyl ammonium acetate) and tetrabutylammonium acetate (TBAA). Thus, using trimerization catalysts having phase transfer trimer cations in the presence of a pentane or similar hydrocarbon blowing agent results in foam with faster tack free time and much improved surface cure. The improvement in TFT has importance in foam processing because it directly impacts foam surface cure as well as adhesion to substrates.

1. A composition comprising the contact product of:
(d) at least one active hydrogen-containing compound;
(e) a catalyst composition comprising at least one phase transfer trimer catalyst; and
(f) at least one blowing agent, with the proviso that the at least one blowing agent is not a chlorofluorocarbon.

2. The composition of claim 1, wherein the at least one phase transfer trimer catalyst has the general formula A-CO₂⁻.⁺NR¹R²R³R⁴, where A is H and R¹, R², R³, and R⁴ are each independently methyl, ethyl, propyl, butyl or —CH₂—Ar and Ar is an aryl group; or where A is H, R¹ is —CH₂—CH₂OH or —CH₂—CH(OH)—CH₃, R² is —CH₂—Ar, and R³ and R⁴ are each independently methyl, ethyl, propyl or butyl and Ar is an aryl group; and wherein the blowing agent comprises formic acid.

3. The composition of claim 1, wherein the at least one phase transfer trimer catalyst has the general formula A-CO₂⁻.⁺NR¹R²R³R⁴ where A is H or methyl, R¹ is —CH₂—CH₂OH or —CH₂—CH(OH)—CH₃, R² is —CH₂—Ar and Ar is an aryl group, and R³ and R⁴ are each independently methyl, ethyl, propyl or butyl; or where A is H or methyl, R¹ and R² and R³ are each independently methyl, ethyl, propyl or butyl, and R⁴ is —CH₂—Ar and Ar is an aryl group; or A is H or methyl, and R¹ and R² and R³ and R⁴ are each independently a C₁-C₄ alkyl group; and wherein the blowing agent comprises a C₅-hydrocarbon blowing agent.

4. The composition of claim 1, wherein the at least one phase transfer trimer catalyst has the general formula A-CO₂⁻.⁺NR¹R²R³R⁴ where A is ethyl and R¹, R², R³, and R⁴ are each independently methyl, ethyl, propyl, butyl or —CH₂—Ar and Ar is an aryl group; and wherein the blowing agent comprises a C₅-hydrocarbon blowing agent.

5. The composition of claim 1, wherein the at least one phase transfer trimer catalyst has the general formula A-CO₂⁻.⁺NR¹R²R³R⁴ where A is propyl and R¹, R², R³, and R⁴ are each independently methyl, ethyl, propyl, butyl or —CH₂—Ar and Ar is an aryl group; and wherein the blowing agent comprises a C₅-hydrocarbon blowing agent.

6. The composition of claim 2, wherein Ar is —C₆H₅.

7. The composition of claim 2, wherein the at least one phase transfer trimer catalyst comprises at least one member selected from the group consisting of tetramethylammonium formate, tetraethylammonium formate, tetrapropylammonium formate, tetrabutylammonium formate, benzyltrimethylammonium formate, benzyltrimethylammonium formate, benzyl-(2-hydroxypropyl)-dimethylammonium formate, and benzyl-(2-hydroxyethyl)-dimethylammonium formate.

8. The composition of claim 3, wherein the at least one phase transfer trimer catalyst comprises at least one member selected from the group consisting of tetramethylammonium acetate, tetraethylammonium acetate, tetrapropylammonium acetate, tetrabutylammonium acetate, tetrabutylammonium formate, benzyltrimethylammonium formate, benzyltrimethylammonium acetate, benzyl-(2-hydroxypropyl)-dimethylammonium acetate and benzyl-(2-hydroxyethyl)-dimethylammonium acetate.

9. The composition of claim 4, wherein the at least one phase transfer trimer catalyst comprises at least one member selected from the group consisting of tetramethylammonium propionate, tetraethylammonium propionate, tetrapropylammonium propionate, tetrabutylammonium propionate, and benzyltrimethylammonium propionate.

10. The composition of claim 5, wherein the at least one phase transfer trimer catalyst comprises at least one member selected from the group consisting of tetramethylammonium butyrate, tetraethylammonium butyrate, tetrapropylammonium butyrate, tetrabutylammonium butyrate, and benzyltrimethylammonium butyrate.

11. The composition of claim 1, further comprising a tertiary amine having or not an isocyanate reactive group.

12. The composition of claim 1, further comprising at least one additive selected from at least one cell stabilizer, at least one flame retardant, at least one chain extender, at least one epoxy resin, at least one acrylic resin, at least one filler, at least one pigment, or any combination thereof.

13. A method for preparing a polyisocyanurate/polyurethane foam comprising contacting at least one polyisocyanate with at least one active hydrogen-containing compound in the presence of at least one blowing agent and a catalyst composition comprising at least one phase transfer trimer catalyst, wherein the at least one blowing agent is not a chlorofluorocarbon.

14. The method of claim 13, wherein the at least one phase transfer trimer catalyst has the general formula A-CO₂⁻.⁺NR¹R²R³R⁴, where A is H and R¹, R², R³, and R⁴ are each independently methyl, ethyl, propyl, butyl or —CH₂—Ar and Ar is an aryl group; or where A is H, R¹ is —CH₂—CH₂OH or —CH₂—CH(OH)—CH₃, R² is —CH₂—Ar, and R³ and R⁴ are each independently methyl, ethyl, propyl or butyl and Ar is an aryl group; and wherein the blowing agent comprises formic acid.

15. The method of claim 13, wherein the at least one phase transfer trimer catalyst has the general formula A-CO₂⁻.⁺NR¹R²R³R⁴ where A is H or methyl, R¹ is —CH₂—CH₂OH or —CH₂—CH(OH)—CH₃, R² is —CH₂—Ar and Ar is an aryl group, and R³ and R⁴ are each independently methyl, ethyl, propyl or butyl; or where A is H or methyl, R¹ and R² and R³ are each independently methyl, ethyl, propyl or butyl, and R⁴ is —CH₂—Ar and Ar is an aryl group; or A is H or methyl, and R¹ and R² and R³ and R⁴ are each independently a C₁-C₄ alkyl group; and wherein the blowing agent comprises a C₅-hydrocarbon blowing agent.

16. The method of claim 13, wherein the at least one phase transfer trimer catalyst has the general formula A-CO₂⁻.⁺NR¹R²R³R⁴ where A is ethyl and R¹, R², R³, and R⁴ are each independently methyl, ethyl, propyl, butyl or —CH₂—Ar and Ar is an aryl group; and wherein the blowing agent comprises a C₅-hydrocarbon blowing agent.

17. The method of claim 13, wherein the at least one phase transfer trimer catalyst has the general formula A-CO₂⁻.⁺NR¹R²R³R⁴ where A is propyl and R¹, R², R³, and R⁴ are each independently methyl, ethyl, propyl, butyl or —CH₂—Ar and Ar is an aryl group; and wherein the blowing agent comprises a C₅-hydrocarbon blowing agent.

18. The method of claim 13, wherein Ar is —C₆H₅.

19. The method of claim 14, wherein the at least one phase transfer trimer catalyst comprises at least one member selected from the group consisting of tetramethylammonium formate, tetraethylammonium formate, tetrapropylammonium formate, tetrabutylammonium formate, benzyltrimethylammonium formate, benzyltrimethylammonium formate, benzyl-(2-hydroxypropyl)-dimethylammonium formate, and benzyl-(2-hydroxyethyl)-dimethylammonium formate.

20. The method of claim 15, wherein the at least one phase transfer trimer catalyst comprises at least one member selected from the group consisting of tetramethylammonium acetate, tetraethylammonium acetate, tetrapropylammonium acetate, tetrabutylammonium acetate, tetrabutylammonium formate, benzyltrimethylammonium formate, benzyltrimethylammonium acetate, benzyl-(2-hydroxypropyl)-dimethylammonium acetate and benzyl-(2-hydroxyethyl)-dimethylammonium acetate.

21. The method of claim 16, wherein the at least one phase transfer trimer catalyst comprises at least one member selected from the group consisting of tetramethylammonium propionate, tetraethylammonium propionate, tetrapropylammonium propionate, tetrabutylammonium propionate, and benzyltrimethylammonium propionate.

22. The method of claim 17, wherein the at least one phase transfer trimer catalyst comprises at least one member selected from the group consisting of tetramethylammonium butyrate, tetraethylammonium butyrate, tetrapropylammonium butyrate, tetrabutylammonium butyrate, and benzyltrimethylammonium butyrate.

23. The method of claim 13, wherein the catalyst composition is present in combination with a tertiary amine having or not an isocyanate reactive group.

24. A method for preparing a polyisocyanurate/polyurethane foam comprising
(a) forming a premix comprising:
i) at least one polyol;
ii) about 1 to about 80 parts by weight per hundred weight parts of the polyol (pphp) blowing agent;
iii) about 0.5 to about 10 pphp silicon surfactant;
iv) zero to about 10 pphp water;
v) zero to about 50 pphp flame retardant;
vi) zero to about 10 pphp urethane catalyst; and
vii) about 0.05 to about 10 pphp of a catalyst composition comprising at least one phase transfer trimer catalyst; and
(b) contacting the premix with at least one polyisocyanate at an isocyanate index from about 80 to about 800.
